(19) United States
(12) Patent Application Publication
(10) Pub. No.: US 2026/0242190 A1
(43) Pub. Date: Aug. 20, 2026

(54) AIR FILTER LIFT ASSEMBLY

(71) Applicant: David Thomas Rutledge, Scottsdale, AZ (US)

(72) Inventor: David Thomas Rutledge, Scottsdale, AZ (US)

(21) Appl. No.: 19/564,436

(22) Filed: Mar. 12, 2026

Related U.S. Application Data
(63) Continuation-in-part of application No. PCT/US2025/056095, filed on Nov. 19, 2025.
(60) Provisional application No. 63/743,083, filed on Jan. 8, 2025.

(51) Int. Cl. B66D 3/20; F24F 13/28

(52) U.S. Cl. CPC B66D 3/20; F24F 13/28

(57) ABSTRACT

A filtered vent system for a return air duct in a ceiling. The vent system includes a mounting frame for fixation to the ceiling. The vent frame is mounted to the mounting frame. A vent plate carrying an air filter. A hoist arrangement is mounted to the vent frame and connected to the vent plate. The hoist arrangement is actuable via electrical power to move the vent plate from a first state in the vent frame to a second state axially outside the vent frame and spaced apart from the vent frame a distance permitting removal of the air filter.

### CROSS-REFERENCE TO RELATED PATENT APPLICATIONS

This patent application is a continuation-in-part of International Application No. PCT/US2025/056095, filed on Nov. 19, 2025, which claims the benefit of priority to U.S. Provisional Application No. 63/743,083, filed Jan. 8, 2025. The entire teachings and disclosure of each of these listed patent applications are incorporated herein by reference thereto.

### FIELD OF THE INVENTION

This invention generally relates to air return vents and more particularly to filtered vent systems for the return air in commercial buildings and residential homes with heating, ventilation, and air conditioning systems.

### BACKGROUND OF THE INVENTION

Residential homes and commercial buildings typically have HVAC (heating, ventilation, and air conditioning) systems to regulate the home or building's internal air temperature as well as to improve indoor air quality. HVAC systems draw in air, referred to as return air, from the home or building through filtered air return vents. The filtered air return vents are typically located in the ceilings of the homes or buildings.

Depending on the size of the filtered air return vent, typically, it is recommended that the air filters in the return vents be checked monthly to see if they have accumulated an amount of particulate that prevents them from permitting sufficient air flow therethrough (a dirty filter). When too much particulate accumulates in the air filter, air flow slows or stops and thereby prevents the HVAC system from operating efficiently or at all.

When the HVAC system is operating with a dirty filter in the air return vent, air within the home or building may not be sufficiently filtered to provide for the desired healthy, “quality” clean air in the home or building. Because of this, manufacturers of the HVAC systems may recommend that the air filters be checked at least monthly and/or changed out monthly to ensure the HVAC system operates efficiently with proper filtered air flow to sufficiently filter the air and to properly cool, ventilate, and heat the home or building while maintaining healthy air within the home or building.

Far too often, the air filters in the air return vents are not checked nor changed out regularly because of the imposition it requires, namely having to access the ceiling of a home or building where the filtered air vent is located. Indeed, to change the air filter in the air return vent, a ladder is required to reach the return vent located in the ceiling. However, dragging a ladder, reaching above one's head to open a cover of the filter housing while also holding the replacement air filter, swapping out the dirty air filter with a new air filter, and then carefully descending a ladder while holding a dirty air filter is simply cumbersome and fraught with issues of safety and cleanliness.

FIG. 12 illustrates a user 300 on a ladder with his arms over his head attempting to change out an air filter 302 located in a return air duct 304 of a home. The air filter 302 is located in a vent return housing 306 and covered by a grille 308 that is connected via hinges to the vent return housing 306 mounted in the ceiling 310. This is a problem, especially for an aging population relying on clean air but lacking the full physical strength, mobility, and endurance to climb up on a ladder on a regular basis and clean or replace the existing air filter 302 in the vent return housing 306.

To date, prior art efforts to address the problem of changing out air filters in return vents installed in ceilings have not solved the problems discussed above. For example, U.S. Pat. No. 9,127,856 to Joseph W. Cole entitled, “Method and System for Replacing Air Filter” and its family of patents (hereinafter, “the Cole patents), U.S. Pat. Nos. 10,960,339; 10,520,216; 10,527,315; 10,376,827; and U.S. Publication No. 2021/0213382 have not overcome the foregoing problems.

While Cole seeks to provide for retrofitting current return vents, the system requires users to completely remove the permanently installed vent return housing and grille intake before installation. Cole's system is installed within the ceiling and retrofitted to current size airduct return. With Cole's system, the user must pull the filter housing down under tension against a biasing force. The filter housing is pulled down with a pole that is rotated in reverse while the housing is pulled back up into place using the pole. Thus, while the user is pulling down the filter housing of Cole, the pole can unexpectedly disconnect resulting in its filter housing retracting into the ceiling and possibly injuring the user.

Cole's system includes a control tool base that is large and includes a dolly, requiring more storage space. Cole's control tool pole is cumbersome and not user friendly because it requires the user to synchronize multiple places on its pole to rotate for length and locking, as well as to raise and lower. Cole's system is unsteady with the control tool attached to the moveable filter housing, as a user could mistakenly kick or knock into the pole which would cause the filter housing to unsafely sway on its cables. Cole's retrofit installation requires complete removal of the old system, with potential for requiring drywall and paint repair for the ceiling. Thus, Cole's design is best understood as a design for new construction and not a retrofit that can be used with existing return vents.

Cole's system does not use the existing frame in its retrofit and has multiple elements, for example its mounts for its cables that must be attached inside the ceiling on the filter housing. This makes for difficult installation as the user must access and find suitable locations if any inside the ceiling. Cole's biased cables, in connection with its pole to raise and lower its filter, are not user friendly and are awkward to use, and therefore discourage the user from making the required filter checks for change out.

### BRIEF SUMMARY OF THE INVENTION

Improving air quality can be achieved by changing the air filters that filter a home or building's air more often. Doing so, however, requires a retrofit adjustment to the current return air filtered vent system in a ceiling.

The invention provides such a filtered vent system and method for its installation that allows for the existing frame in the ceiling to remain in place while only the existing vent plate of the existing return air vent system is removed. These and other advantages of the invention, as well as additional inventive features, will be apparent from the description of the invention provided herein.

In one aspect, the invention provides a filtered vent system for a return air duct in a ceiling. The vent system includes a bracket configured to mount to the ceiling. A vent frame is configured to be mounted to the bracket to fix the frame to the ceiling. A vent plate carries an air filter. A hoist arrangement is mounted to the vent frame and connected to the vent plate. The hoist arrangement is actuable through an aperture in the frame to move the vent plate from a first state in contact with the frame to a second state free from contact with the frame and spaced apart from the frame a distance permitting removal of the filter.

In an embodiment, the bracket is a pair of brackets configured to mount on opposite sides of the air duct.

In an embodiment, each one of the pair of brackets includes a bracket body. A plurality of arm members extend away from the bracket body in a direction generally perpendicular to the bracket body and the ceiling. The plurality of arm members are spaced apart from one another in parallel relation. Each one of the plurality of arm members includes a first portion in contact with the bracket body and a mounting portion free from contact with the mounting portion.

In an embodiment, the mounting portion includes a plurality of detent members. The frame includes a plurality of apertures. Each one of the detent members is received into a respective one of the plurality of apertures of the frame so as to mount the frame to the bracket.

In an embodiment, the frame is configured to surround the air duct without any portion thereof extending into the air duct.

In an embodiment, the actuator extends through the aperture to actuate a gear assembly of the hoist arrangement mounted to the frame.

In an embodiment, the actuator rotates in a first actuation direction to actuate the gear assembly to turn in a first direction to rotate a plurality of pulleys in a pulley system of the hoist arrangement to move the vent plate from the first state to the second state.

In an embodiment, the actuator moves in a second actuation direction, opposite the first actuation direction to actuate the gear assembly to turn in a second direction opposite the first direction to rotate the plurality of pulleys in the pulley system to move the vent plate from the second state to the first state. In the first state, the vent plate is in contact with the frame.

In an embodiment, the pulley system includes ropes connected to the vent plate in an unbiased state.

In an embodiment, simultaneously the ropes are unwound or wound about the plurality of pulleys so as to lower or raise, by rotation of the plurality of pulleys, the vent plate from the first position to the second position and from the second position to the first position.

In an embodiment, the actuator is mounted to a crank pole. The crank pole with the actuator defines a first length of the crank pole. Rotation of the crank pole in a first rotational direction to actuate the actuator does not change the first length of the crank pole as the vent plate moves from the first position to the second position.

In an embodiment, the first length does not change with rotation of the crank pole in a second rotational direction, opposite the first rotational direction, to move the vent plate from the second position to the first position.

In an embodiment, the vent plate has a vent body having four side walls surrounding a slotted face of the vent body. The side walls are in contact with the frame in the first state.

In an embodiment, the actuator is located on the end of a crank pole.

In an embodiment, the actuator includes a torque limiter.

In an embodiment, the crank pole is moveable between a first longitudinal length and a second longitudinal length.

In an embodiment, the frame does not move as the vent plate moves from the first state to the second state and from the second state to the first state.

In another aspect, the invention provides a method for replacing an existing vent return plate and existing air filter in an existing frame for a filtered return air vent in a ceiling duct. The method includes the steps of removing the existing vent return plate while the existing frame surrounding the vent return plate remains fixed to the ceiling. The method includes the step of removing the existing air filter from the filtered air return vent. The method includes the step of fastening a bracket on a portion of the ceiling surrounding the existing frame. The method includes the step of mounting a new frame carrying a new vent plate with a new air filter to the bracket and over the existing frame. The new vent plate is moveable relative to the new frame between a closed state in contact with the frame to an open state wherein the vent plate is free from contact with the frame.

In an embodiment, the method includes the step of inserting an actuator through the new frame to actuate a hoist arrangement having a gear assembly mounted to the frame and connected to a pulley system connected to the vent plate to lower the vent plate from the closed state to the open state.

In an embodiment, the method includes the step of attaching the actuator to a crank pole to allow a user to insert the actuator through the frame while standing on a floor below the ceiling without the crank pole changing length as the vent plate moves between the closed and open state and between the open and closed state.

In another aspect the invention provides a filtered vent system for a return air duct in a ceiling. The vent system includes a mounting frame for fixation to the ceiling. The filtered vent system includes a vent frame mounted to the mounting frame. The filtered vent system includes a vent plate carrying an air filter. The filtered vent system includes a hoist arrangement mounted to the vent frame and connected to the vent plate. The hoist arrangement is actuable through an aperture in the vent frame to move the vent plate from a first state in the vent frame to a second state axially outside the vent frame and spaced apart from the vent frame a distance permitting removal of the air filter.

In an embodiment, the vent frame includes a plurality of lanyards sized for connecting the vent frame directly to the ceiling.

In an embodiment, the hoist arrangement moves a face of the vent plate such that the face of the vent plate remains substantially parallel to ground as it moves.

In and embodiment, an actuator extends through the aperture to actuate a gear assembly of the hoist arrangement mounted to the vent frame to move the vent plate.

In an embodiment, the actuator extending through the aperture has an end comprising a substantially closed ring.

In an embodiment, a crank pole end includes a hook portion, the hook portion sized to be received into the ring of the actuator.

In an embodiment, the gear assembly comprises a worm gear.

In an embodiment, a longitudinal axis of the worm gear extends generally perpendicularly to a face of the vent plate.

In an embodiment, the hoist arrangement includes ropes coiled about pulleys located on the vent frame. Each one of the ropes having a first end coiled about a drive pulley and a second end that passes over a corner pulley and through a tension block. The second end is fixed to an unbiased tensioning spring seated on the vent frame.

In an embodiment, the unbiased tension spring cooperates with the tension block that receive the rope so as to permit sliding of the rope with resistance and provide alignment and to the vent plate as it moves.

In an embodiment, the distance is greater than 0.5 meters.

In an embodiment, the vent frame comprises a hinge side and a latch side. The vent frame is hingedly connected at the hinged side to the mounting frame and removably fixed at the latch side to the mounting frame.

In yet another aspect the invention provides a method of replacing the air filter of the filter vent system. The method includes actuating the hoist arrangement to move the vent plate from a first state in contact with the vent frame to a second state free from contact with the vent frame. The method includes actuating the hoist arrangement to space the vent frame the distance permitting removal of the air filter and then removing the air filter and replacing it with a new air filter on the vent plate. The method includes actuating the hoist arrangement to move the vent plate from the second state to the first state.

In an embodiment, the distance is greater than 0.5 meters.

In an embodiment, the distance is greater than 1.5 meters.

In an embodiment, the method includes attaching a second end of a crank pole to the hoist arrangement. The method includes rotating a first end of the crank pole in a first rotational direction to rotate the crank pole in the first rotational direction to actuate the hoist arrangement to move the vent plate in a first direction from the first state to the second state. The method includes rotating the second end of the crank pole in a second rotational direction, opposite the first rotational direction to rotate the crank pole in the second rotational direction to actuate the hoist arrangement to move the vent plate in a second direction opposite the first direction from the second state to the first state.

In an embodiment, the method includes attaching a hand drill to the first end of the crank pole. The method includes actuating the hand drill to rotate the crank pole in the first rotational direction to move the vent plate from the first state to the second state. The method includes actuating the hand drill to rotate the crank pole in the second rotational direction opposite the first rotational direction to move the vent plate from the second state to the first state.

In yet another aspect, the invention provides for a filtered vent system for a return air duct in a ceiling. The filtered vent system includes a bracket configured to mount to the ceiling. The filtered vent system includes a vent plate carrying an air filter. The filtered vent system includes a hoist arrangement mounted to the vent frame and connected to the vent plate. The hoist arrangement is actuable via electrical power to move the vent plate from a first state in contact with the vent frame to a second state free from contact with the vent frame and spaced apart from the vent frame a distance permitting removal of the air filter.

In an embodiment, the electrical power is provided by utility power.

In an embodiment, the electrical power is provided by a battery.

In an embodiment, the electrical power is supplied to an electrical circuit that includes a three-position switch, a power supply, a two-way relay, a motor, a pair of inline fuses, and a pair of limit switches.

In an embodiment, the three position switch includes a spring that biases the switch in a first position that is an off position wherein no electrical power is supplied to the motor.

In an embodiment, the three position switch has a second position that triggers the two way relay to allow electrical current of the electric power to flow to the motor to turn the motor in a first rotational direction and move the vent plate from the first state to the second state.

In an embodiment, the three position switch has a third position that triggers the two way relay to allow the electrical current to flow to the motor to turn the motor in a second rotational direction, opposite the first rotational direction, to move the vent plate from the second state to the first state.

In an embodiment, the pair of limit switches are configured to stop the motor when the vent plate moves from the second state to the first state.

In an embodiment, the pair of limit switches are located at opposite diagonal corners of the vent frame and are wired in parallel. The pair of limit switches are activated when the vent plate reaches the second state. To maintain the vent tray in a level position, both limit switches of the pair of limit switches must be activated to stop the motor and keep the vent plate in the second state.

In an embodiment, the pair of inline fuses prevent the motor from overheating.

In an embodiment, the hoist assembly includes an axel rotatably mounted on the vent frame. A first end of the axel is located on a first side of the vent frame and a second end of the axel located on a second side of the vent frame opposite the first side. A gear and a first central pulley are mounted at the first end of the axel. A second central pully is mounted at the second end of the axel. A motor is configured to rotationally turn the gear, the axel, the first central pulley and the second central pulley.

In an embodiment, the hoist arrangement includes a power supply, the power supply supplying the electrical power to the motor.

In an embodiment, the hoist arrangement includes a first set of pulleys mounted to the frame and connected to the first central pulley and a second set of pulleys mounted to the frame and connected to the second central pulley.

In an embodiment, a first portion of ropes connect the first set of pulleys to the first central pulley and to the vent plate and a second portion of ropes connect the second set of pulleys to the second central pulley and to the vent plate.

In an embodiment, the first set of pulleys are connected to the second set of pulleys by a first axel at a first end of the frame and by a second axel at a second end of the frame. The axel is located between the first axel and the second axel.

In an embodiment, the first central pulley, the second central pulley, the first set of pulleys and the second set of pulleys are rotatable in a first rotational direction and a second rotational direction opposite the first rotational direction.

In an embodiment, the first portion of ropes and the second portion of ropes are in an unbiased state in the first state of the vent plate and in the second state of the vent plate and in any position between the first state of the vent plate and the second state of the vent plate.

In an embodiment, rotation of the motor in either the first rotational direction or the second rotational direction simultaneously rotates the first central pulley, the first set of pulleys and the second central pulley and the second set of pulleys to either unwind or wind the first portion of ropes and the second portion of ropes about the first central pulley and the second central pulley so as to move the vent plate either from the first position to the second position or from the second position to the first position.

In yet another aspect the invention provides a method for replacing an existing vent return plate and existing air filter in an existing frame for a filtered return air vent in a ceiling duct. The method includes the step of removing the existing vent return plate while the existing frame surrounding the vent return plate remains fixed to the ceiling. The method includes the steps of removing the existing air filter from the filtered air return vent. The method includes the step of fastening a bracket on a portion of the ceiling surrounding the existing frame. The method including the step of mounting a new frame connected to a new vent plate with a new air filter to the bracket and over the existing frame, the new vent plate moveable relative to the new frame between a closed state in contact with the new frame to an open state wherein the vent plate is free from contact with the new frame, and wherein the frame includes components for receiving electrical power.

In an embodiment, the method includes the step of providing the electrical power to one of the components that is a motor, the motor mounted on the new frame and configured to rotate to move the new vent plate.

In yet another aspect, the invention provides a filtered vent system for a return air duct in a ceiling. The filtered vent system includes a vent frame configured to be mounted to the ceiling. The filtered vent system includes a vent plate carrying an air filter and a hoist arrangement mounted to the vent frame and connected to the vent plate. The hoist arrangement is actuable to move the vent plate from a first state in contact with the vent frame to a second state free from contact with the vent frame and spaced apart from the vent frame a distance permitting removal of the air filter.

Embodiments of the filtered vent system may have one or more of the following features alone or in combination.

The vent frame defines an aperture configured to receive an actuator therethrough to actuate the hoist arrangement to move the vent plate from the first state in contact with the vent frame to the second state free from contact with the vent frame.

The vent frame is configured to extend less than 12.7 millimeters away from the ceiling when mounted thereto.

The vent frame is configured to extend less than 6.4 millimeters away from the ceiling when mounted thereto.

The hoist arrangement is actuable via electrical power to move the vent plate.

The vent frame includes a front frame member, a back frame member spaced apart from the front member and in parallel relation to the front member. The vent frame includes a first side member, a second side member spaced apart from the first side member and in parallel relation to the second side member. The first side member and the second side member each extend between the first frame member and the back frame member.

The hoist assembly includes an axel rotatably mounted on the vent frame. A first end of the axel is located on either the front side member of the vent frame or the back side member of the vent frame and a second end of the axel that is opposite the first end of the axel is located on either the front side member of the vent frame or the back side member of the vent frame. A gear and a first central pulley are mounted on either the front side member or the back side member and a second central pully mounted at the second end of the axel; a motor mounted on either the front side member or the back side member. The motor is configured to rotationally turn the gear, the axel, the first central pulley, and the second central pulley.

The electrical power is supplied to an electrical circuit that includes a three-position switch, a power supply, a two-way relay, a motor, a pair of inline fuses, and a pair of limit switches.

The three position switch includes a spring that biases the switch in a first position that is an off position wherein no electrical power is supplied to the motor.

The three position switch has a second position that triggers the two-way relay to allow electrical current of the electric power to flow to the motor to turn the motor in a first rotational direction and move the vent plate from the first state to the second state.

The three position switch has a third position that triggers the two way relay to allow the electrical current to flow to the motor to turn the motor in a second rotational direction, opposite the first rotational direction, to move the vent plate from the second state to the first state.

The pair of limit switches are configured to stop the motor when the vent plate moves from the second state to the first state.

The motor is located on either the front frame member or the back frame member.

The filter vent system is configured to mount to the ceiling by fixing the first side member or the second side member to adjacent rafters such that the motor is located between the adjacent rafters.

A handheld device transmits a signal to energize the electrical circuit to energize the motor so as to raise or lower the vent plate as desired by the user.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 illustrates a filtered vent system according to the teachings of the instant invention installed around a preexisting frame in a ceiling of a home or commercial building and in a closed state;

FIG. 2 is a view of the filtered vent system of FIG. 1 as seen by a user standing on the floor and looking up at the ceiling;

FIG. 3 is a partial assembly view of the filtered vent system of FIG. 1 showing brackets of a frame of the filtered vent system surrounding the preexisting frame;

FIG. 4 is another partial assembly view of the filtered vent system of FIG. 1 with the frame in position to mount to the brackets of the frame;

FIG. 5 is partial assembly view of the frame of the filtered vent system of FIG. 1;

FIG. 6 is a partial assembly view of the bracket of the frame and an inner flange of the frame of the filtered vent system of FIG. 1;

FIG. 7 illustrates a second state, that is an open state, of the filtered vent system of FIG. 1 with the brackets of the frame removed for purposes of illustration;

FIG. 8 illustrates a vertical cross section through a frame member of FIG. 7 at line 8-8;

FIG. 9 illustrates a central pulley of the filtered vent system of FIG. 1;

FIG. 10 illustrates a torque limiter of an actuator on a crank pole for actuation the filtered vent system of FIG. 1;

FIG. 11 illustrates the filtered vent system of FIG. 1 with a second embodiment of a hoist arrangement;

FIG. 12 illustrates a user changing a filter of a prior art filtered vent system;

FIG. 13 illustrates another embodiment of a filtered vent system according to the teachings of the instant invention and in a closed state and with the filter removed to show the vent plate;

FIG. 14 illustrates FIG. 14 illustrates a mounting frame of the filtered vent system of FIG. 13;

FIG. 15 illustrates the mounting frame of FIG. 14 just prior to installation on a ceiling;

FIG. 16 illustrates the mounting frame of the filter vent system of FIG. 13 installed around a preexisting vent frame in ceiling;

FIG. 17 illustrates a floor facing face the mounting frame of FIG. 14;

FIG. 18 illustrates a latch side of the mounting frame and side of the vent frame of FIG. 1;

FIG. 19 illustrates hinge side of the mounting frame and vent frame of FIG. 13;

FIG. 20 illustrates a hingedly connected vent frame to the mounting frame during an installation of the filter vent system of FIG. 13;

FIG. 21 illustrates a safety lanyard of the vent frame of FIG. 13 attached to a frame in the ceiling;

FIG. 22 illustrates the lever side of the mounting frame and levers of the vent frame of FIG. 13 aligned for connection with the mounting frame of FIG. 14 installed on the ceiling;

FIG. 23 illustrates the installed filter vent system of FIG. 13 on a ceiling;

FIG. 24 illustrates the filter vent system of FIG. 23 being actuated with a crank pole held by a user;

FIG. 25 illustrates the vent plate with a filter seated thereon;

FIG. 26 illustrates a partial cross section taken of the vent frame taken about line 26-26 of FIG. 24 to better illustrate an actuator of the filter vent system of FIG. 13;

FIG. 27 illustrates an end of the crank pole of FIG. 24;

FIG. 28 illustrates the vent frame 102 with frame members removed to better illustrate a hoist arrangement of the filtered vent system of FIG. 13;

FIG. 29 illustrates the filter vent system of FIG. 13 in an open state and with the filter removed;

FIG. 30 illustrates a user actuating the filter vent system of FIG. 13 with a power tool;

FIG. 31 illustrates a top isometric view, that is a view looking from the ceiling to the floor, of another embodiment of a filter vent system and in an open state and with the air filter removed to show the vent plate;

FIG. 32 illustrates a cross section taken about line A-A of FIG. 31 and including the air filter;

FIG. 33A is a circuit diagram of the filter vent system of FIG. 31 in a first, off position;

FIG. 33B is a circuit diagram of the filter vent system of FIG. 31, in a second position to lower the vent plate;

FIG. 33C is a circuit diagram of the filter vent system of FIG. 31, in third position to raise the vent plate;

FIG. 34 illustrates another isometric view of the filter vent system of FIG. 31; and

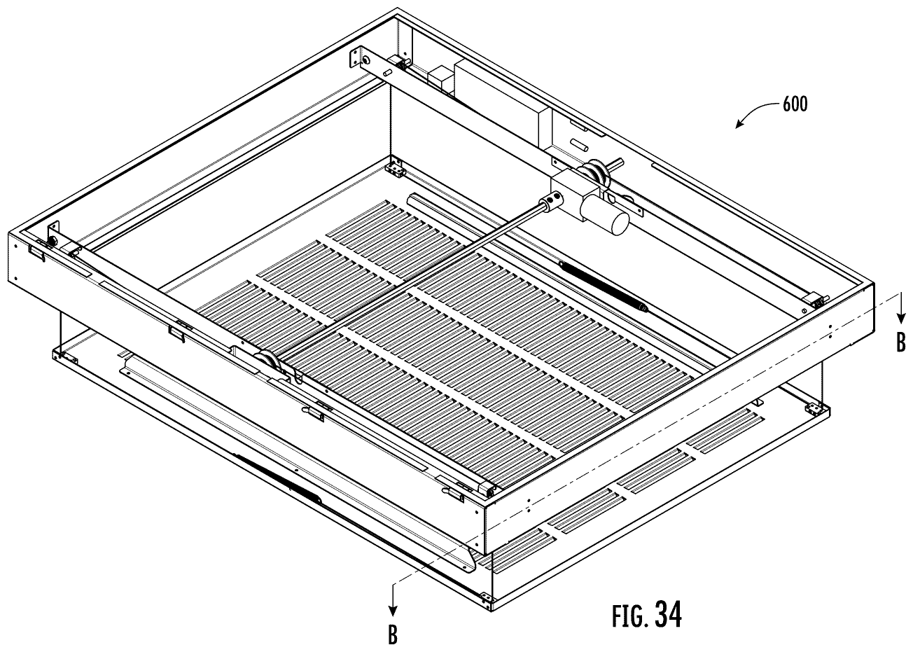

FIG. 35 illustrates a cross section taken about line B-B of FIG. 34.

FIG. 36 illustrates another embodiment of a filter vent system having a vent frame sized and structured to flush mount to a ceiling;

FIG. 37 illustrates the vent frame of FIG. 36 with a filter removed therefrom;

FIG. 38 illustrates a partial assembly view of the vent frame of FIG. 36;

FIG. 39 illustrates a cross section taken about line 39-39 of the filter vent system of FIG. 36; and

FIG. 40 illustrates an electric motor, controller and electrical circuit to move the vent plate of FIG. 36 between open and closed positions.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

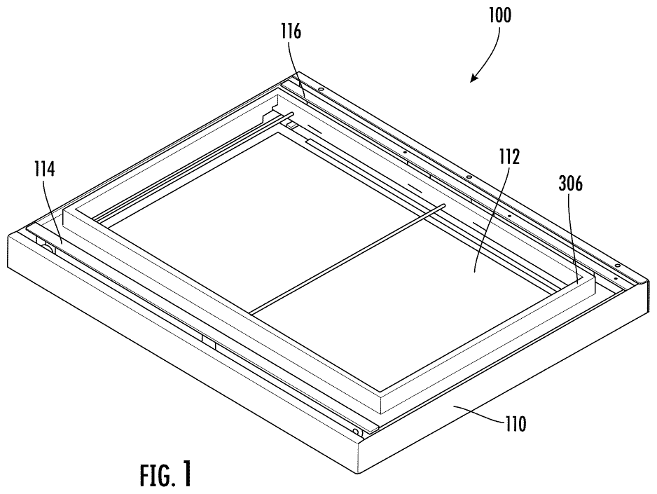

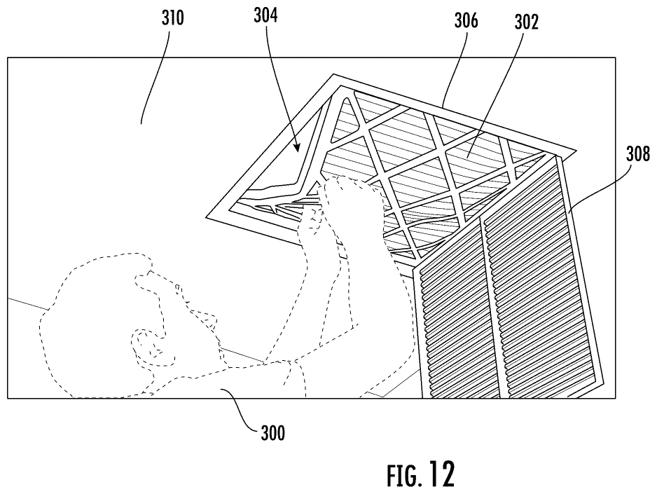

With respect to FIG. 1, according to the teachings of the instant invention, a top view of a filtered vent system 100 for a return air duct 304 (FIG. 12) in a ceiling 310 (FIG. 12) is illustrated. The filtered vent system 100 is shown surrounding a preexisting frame 306 (FIG. 12) that would be in the ceiling 310 (FIG. 12) that surrounds the return air duct 304 (FIG. 12). The filtered vent system 100 is in a first state, that is a closed state.

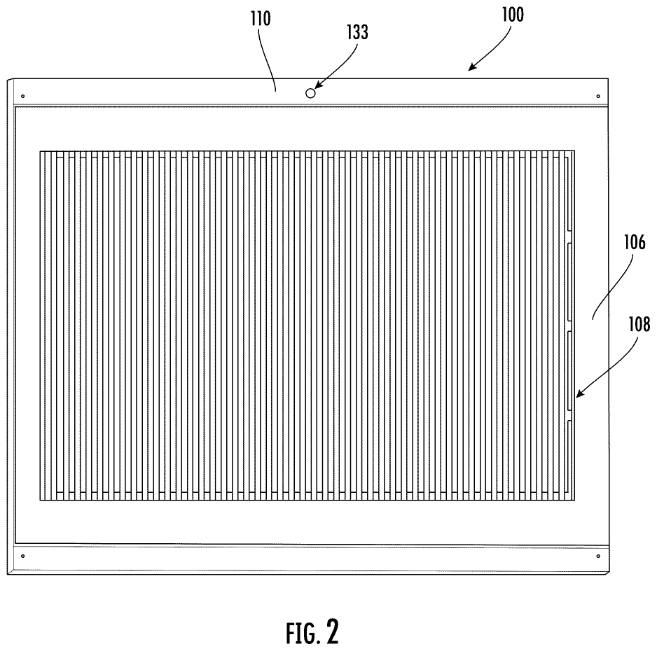

FIG. 2 illustrates a bottom view of the filtered vent system 100 in the closed state as typically seen by a user on a floor looking up at the ceiling.

With respect to FIGS. 1 and 2, in the closed state, return air flows from the from the home or building through a vent plate 106 that has a plurality of openings 108, that may be formed by louvres 109 of the vent plate 106. The vent plate 106 is received into a frame 110 of the filtered vent system 100 in the closed state. The frame 110 surrounds the air duct 304 (FIG. 12) without any portion thereof extending into the return air duct 304 (FIG. 12). After passing through the plurality of openings 108, the return air is filtered through an air filter 112 carried by the vent plate 106. The air filter 112 may be of any known filter media for home and business commonly used to filter return air. After passing through the air filter 112, the return air enters the return air duct 304 (FIG. 12).

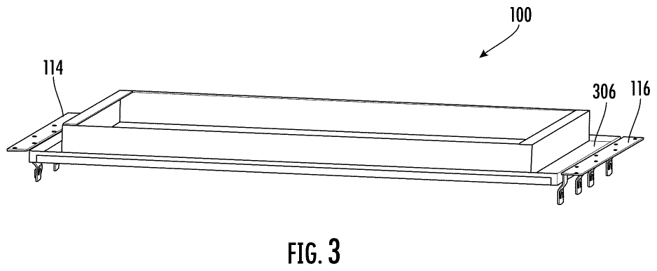

The filtered vent system 100 includes a pair of brackets 114, 116 that are fastened, for example, via screws to the ceiling (not illustrated). FIG. 3 illustrates a partial view of the frame 110, namely the brackets 114, 116 that mount to the ceiling on opposite sides of the preexisting vent frame 306. Thus, it should be readily appreciated that the filtered vent system 100 is easy to install because the preexisting vent frame 306 does not have to be removed. The preexisting vent frame 306 remains fixed in place while only its louvered vent plate 308 (FIG. 12) and air filter 302 (FIG. 12) are removed in order to install the filtered vent system 100. While a pair of brackets 114, 116 is illustrated, a single bracket, or more than two brackets, could be used to mount the frame 110 of the filtered vent system 100 to the ceiling. Typically, the brackets 114, 116 are of metal.

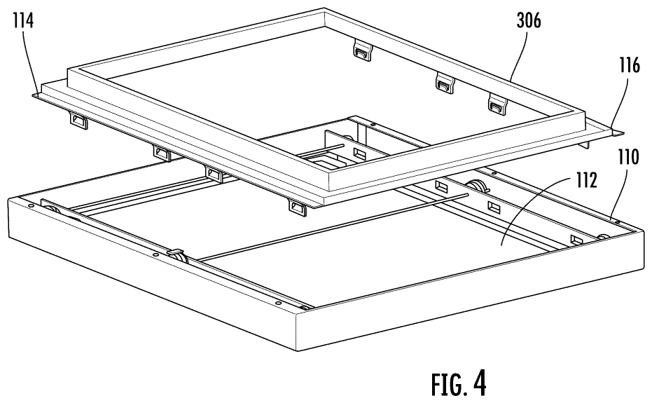

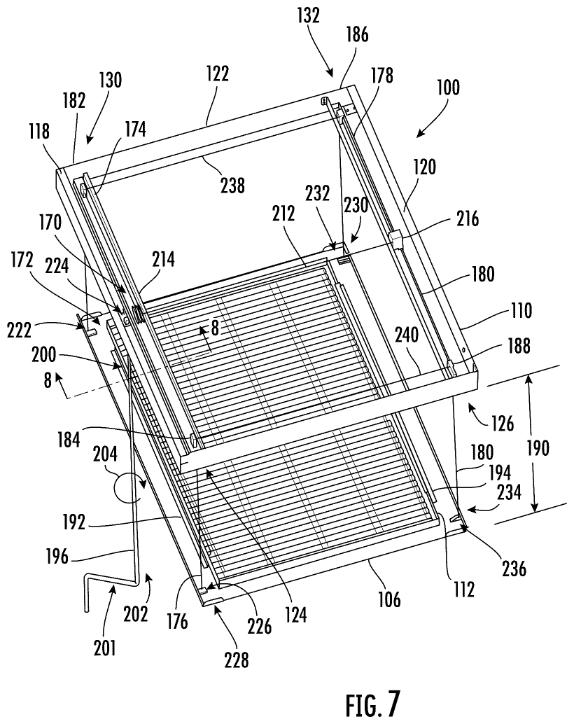

FIG. 4 is a partial assembly view illustrating the brackets 114, 116 as if mounted to the ceiling (not illustrated) on opposed sides of the preexisting frame 306 with the frame 110 positioned below the preexisting frame 306 with the vent plate 106 (FIG. 2) carrying the air filter 112 inside the frame 110 in position to be mounted to the brackets 114, 116. Once the frame 110 is mounted to the brackets 114, 116, the frame 110 is fixed in place. The vent plate 106 (FIG. 2) carrying the air filter 112 is not part of the frame 110. The vent plate 106 (FIG. 2) carrying the air filter 112 is moveable between the first state, that is the closed state, where the vent plate 106 (FIG. 2) is in contact with the frame 110 to a second state, that is an open state (See FIG. 7), wherein in the vent plate 106 (FIG. 2) carrying the air filter 112 is outside the frame 110. The frame 110 and the vent plate 106 are typically made of metal.

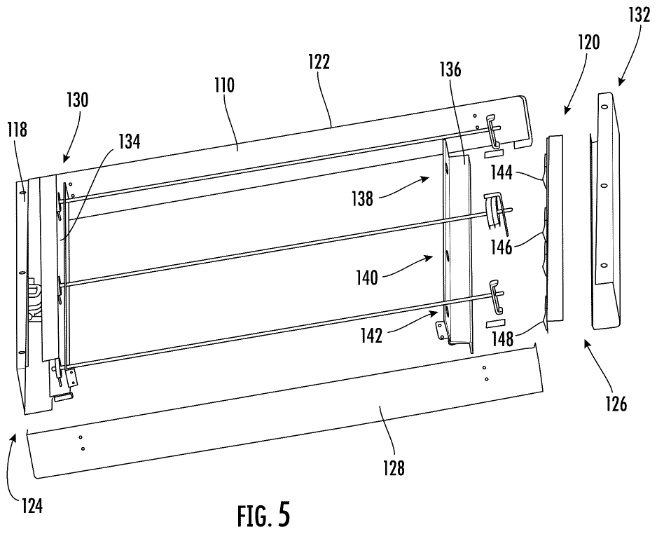

FIG. 5 illustrates a partial assembly view of the frame 110. Frame 110 includes a main frame member 118 spaced apart from another main frame member 120 which is shown in assembly view. An endcap 122 connects the main frame member 118 and main frame member 120 at first ends 124, 126, and another endcap 128 connects the main frame member 118 and main frame member 120 at second ends 130, 132. The main frame members 118, 120 may be connected by any known fastener means, for example, screws. The main frame members 118, 120 and the end caps 122, 126 may be considered the four walls of the frame 110 that are in contact with the vent plate 106 in the closed state and which are not in contact with the vent plate 106 when the filtered vent system 100 is in the open state.

Main frame member 118 includes a through hole 133 (FIG. 2) which is an opening for receiving an actuator 136 (FIG. 7) therethrough. Main frame member 118 include an inner flange 134. Main frame member 120 includes an inner flange 136. Each inner flange 134, 136 is structured the same, and therefore only inner flange 136 is discussed with the understanding that the same structures and relationship therebetween is present on flange 134.

The inner flange 136 includes a plurality of through holes 138 that are apertures that mount via reception therein by a plurality of detents 144 located on the brackets 116. Bracket 116 is structured the same as bracket 114, and therefore only bracket 116 is discussed.

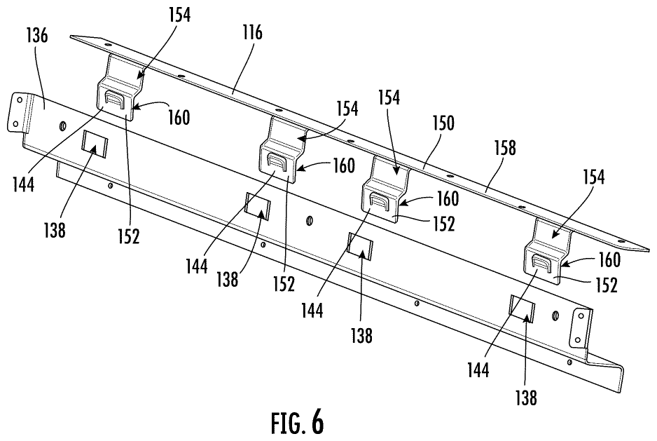

FIG. 6 better illustrates the plurality of detents 144 of the bracket 116 and the plurality of through holes 138, 140, 142 of the inner flange 136. Bracket 116 includes a bracket body 150 and a plurality of arm members 152 extending away from the bracket body 150 in a direction generally perpendicular to a planar surface 158 of the bracket body 150. In other words, when bracket 116 is mounted to the ceiling the arm members 152 extend in a direction away from the ceiling. By generally, it is meant within plus or minus five degrees. The plurality of arm members 152 are spaced apart from one another in parallel relation. Each one of the plurality of arm members 152 has a first portion 154 in contact with the bracket body 150 and a mounting portion 160 free from contact with the bracket body 150.

Each mounting portion 160 includes one of the plurality of detents 144. Each one of the detents 144 is received into one of the through holes 138 of the inner flange 136 of the frame 110 (FIG. 5) so as to mount the frame 110 (FIG. 5) to the bracket 116.

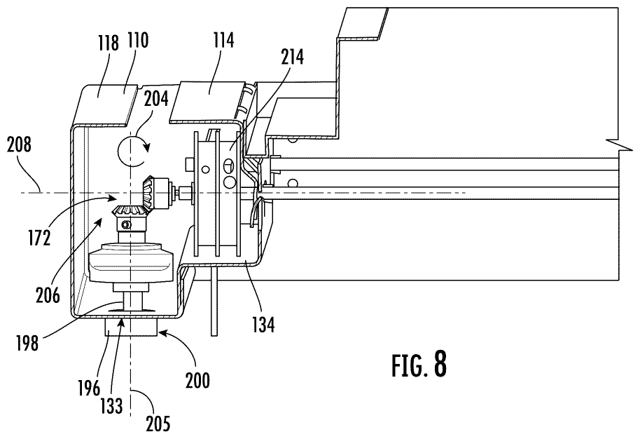

FIG. 7 illustrates a second state of the filtered vent system 100 with the brackets 114, 116 (FIG. 1) removed for the purposes of illustration. The second state is an open state wherein the vent plate 106 carrying the air filter 112 has been lowered out of the frame 110 via a hoist arrangement 170 that includes a gear assembly 172 (FIG. 8), ropes 174, 176, 178, 180 and pulleys 182, 184, 186, 188. In the open state, the vent plate 106 carrying the air filter 112 has been lowered a distance 190 sufficient to permit a user to view the air filter 112 for cleanliness and to remove the air filter 112 for either further inspection or to change it out with a new air filter 112. By “sufficient distance” 190, it is meant a distance between the frame 110 and the vent plate 106 carrying the air filter 112 that allows for a user to easily remove the air filter 112 from the vent plate 106. The distance will typically allow a user standing on the floor to easily remove the air filter 112 from the vent plate 106.

The air filter 112 is held in place by a pair of retaining members 144, 146 located on opposite sides of the air filter 112 and permitting the air filter 112 to be slid into and out of the retaining members 144, 146. While a pair of retaining members 192, 194 are shown, any number of known retaining devices can be used, for example, only one of the retaining members 192, 194, or a latch or plurality of latches that can be rotated to cover a portion of the air filter 112 or rotated to uncover the portion of the air filter 112 so as to permit removal of the air filter from the vent plate 106.

In order to move the vent plate 106 from the closed position (FIG. 1) to the open position a user holds a crank pole 196 having an actuator 198 (FIG. 8) attached at an engagement end 200 of the crank pole 196 and a handle portion 201 at the opposite end 202 of the crank pole 196. The actuator 198 (FIG. 8) is inserted through the hole 133 (FIG. 8) in the main frame member 118. However, the other frame member 120 or end caps 122, 124 could provide the opening 133 (FIG. 8). A user turns the handle portion 201 to turn the actuator 198 so as to impart a rotational force 204 that may be clockwise in a first direction and counterclockwise in a second direction opposite the first direction as desired to actuate the hoist arrangement 170.

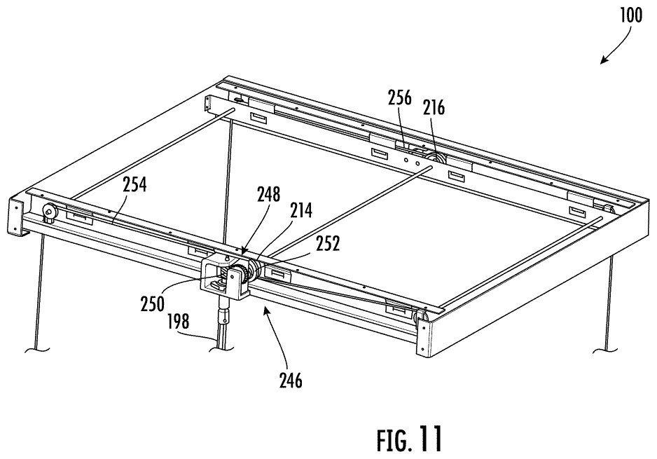

The actuator 198 is inserted into a frame opening 202 to actuate a gear assembly 204 of the hoist arrangement 170 (FIG. 8). FIG. 8 is a vertical cross taken through the main frame member 118, inner flange 134 and including bracket 114 (not present in FIG. 7) at line 8-8 of FIG. 7. A stepped channel 206 is defined by the main frame member 118 and the inner flange 134. The gear assembly 172 is mounted inside the stepped channel 206 of the frame 110. The gear assembly 172 converts the rotational force 204 of the actuator 198 from rotation about a first axis 205 defined by the longitudinal axis of the actuator 198 to a second axis 208 defined by a longitudinal axis of an axle 212 connecting a first central pulley 214 to another central pulley 216 (FIG. 7) located on frame member 120 (FIG. 7). The gear assembly 172 comprises a first beveled gear 218 driven by the actuator 198 that turns a second beveled gear 220 which turns the first central pulley 214 and axle 212 and the second central pulley 216. Other gear assemblies 172 are possible, for example, the gear assembly 172 may be a worm gear 250 (FIG. 11) driven by the actuator 198 that turns gear 252 (FIG. 11) which turns the first central pulley and axle 212 and the second central pulley 216.

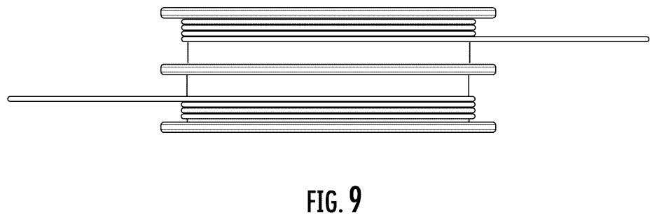

The first central pulley 214 and second central pulley 216 are each dual spool (FIG. 9) and can spool two of the ropes 174, 176, 178, 180 simultaneously based on their wound direction. Thus, the first central pulley 214 includes rope 174 and rope 176 spooled thereon. (FIG. 9) Rope 174 extends over pulley 182 mounted at the second end 130 of the main frame member 118. An end 222 of the rope 174 connects to vent plate 106 at a first corner 224. Rope 176 extend over pulley 184 at the first end 124 of the main frame member 118. An end 226 of the rope 176 connects to the vent plate 106 at a second corner 228.

The second central pulley 216 mounted on main frame member 120 has ropes 178 and 180 spooled thereon. Rope 178 extends over pulley 186 mounted on the second end 132 of main frame member 120. An end 230 of the rope 178 connects to the vent plate 106 at a third corner 232 of the vent plate 106. Similarly, rope 180 extends over pulley 188 mounted on the first end 126 of the main frame member 120. An end 234 of the rope 180 connects at a fourth corner 236 of the vent plate 106. Axle 238 connects pulleys 182 and 184, while axle 240 connects pulleys 186, 188.

It can now be readily appreciated that the actuator 198 actuates the hoist arrangement 170 to either lower or raise the vent plate 106 as desired. The hoist arrangement 170 is not biased to either keep the vent plate 106 in the closed position (FIG. 1) or the open position (FIG. 7). Sufficient length of the ropes 174, 176, 178, 180, 182 is provided to permit a user standing on the floor to lower the vent plate 106 to a height above the floor and at a sufficient distance 190 from the frame 110 to permit the user to easily reach the air filter 112 carried by the vent plate 106 without having to use a ladder or reach overhead. The pulleys 174, 176, 180, 182 and ropes 174, 176, 178, 180 and axles 212 238, 240 together make up pulley system 242 of the hoist arrangement 170.

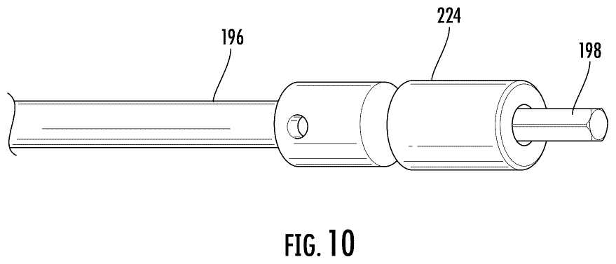

FIG. 10 illustrates the actuator 198 mounted on crank pole 196. Actuator 198 may include a torque limiter 244 to prevent over torque of the gear assembly 172 (FIG. 8). However, as can be readily appreciated, the crank pole 196 may be of many different designs provided that it can be easily extended or contracted by the user to read the gear assembly 172 (FIG. 8) and while a torque limiter 244 may provide known advantages, it does not have to be present on the actuator 198 as the user can use their experience to prevent over-torque of the gear assembly 172 (FIG. 8).

Returning to FIG. 7 and FIG. 8, crank pole 196 has a changeable longitudinal length. By way of non-limiting examples, the crank pole 196 may be collapsible and expandable or a telescoping pole which permits the user to extend the crank pole 196 to reach the frame 110 while the user stands on the floor. It can be readily appreciated at this point in the disclosure that a user can rotate the crank pole 196 in a first rotational direction to rotate the actuator 198 to turn the gear assembly 172 which turns the pulleys 174, 176, 180, 182 to unspool and extend the ropes 174, 176, 178, 180 to lower the vent plate 106 carrying the air filter 112. Rotating the crank pole 196 in a second rotational direction opposite the first rotational direction spools and thereby retract the ropes 174, 176, 178, 180 to raise the vent plate 106 carrying the air filter to the closed state. (FIG. 1). The ropes in the pulley system 242 are in an unbiased state. When the gear assembly 172 stops its rotation, the distance 190 remains fixed until rotation begins again.

At this point in the disclosure, it can be readily appreciated that a user having a home or building with a preexisting vent frame 306 (FIG. 12) in an intake of existing return air duct 304 no longer has to endure the inconvenience of using a ladder to reach overhead to remove the louvered vent plate 308 or try to balance the vent plate 308 as they try to swing it open or lower it in some fashion. Instead, the user can install the filtered vent system 100 by removing the existing louvered vent plate 308 while the preexisting frame 306 remains fixed to the ceiling.

The user then merely has to fasten, with screws in most instances, the pair of brackets 114, 116 (FIG. 3) on a portion of the ceiling 310 (FIG. 12) surrounding the preexisting vent frame 306. Once the brackets 114, 116 (FIG. 3) are installed, the user mounts the new frame 110 (FIG. 1) carrying a new vent plate 106 (FIG. 2) with a new air filter 112 (FIG. 1) to the brackets 114, 116 (FIG. 1) and over the preexisting vent frame 306 (FIG. 1).

The user may thereafter use a crank pole 196 (FIG. 7) that has an actuator 198 (FIG. 8) on its end. The actuator 198 (FIG. 8) is placed to extend through the opening 133 (FIG. 8) in the main frame member 118 (FIG. 8) of the new frame 110 (FIG. 8) to actuate the hoist arrangement 170 (FIG. 8) to lower the vent plate 106 (FIG. 7) carrying the air filter 112 (FIG. 7) from the frame 110 (FIG. 7) to the desired height above the floor. Once at the desired height, the user can easily remove the air filter 112 (FIG. 7) from the vent plate 106 (FIG. 7) for inspection or replacement. Once inspected or replaced, the user uses the crank pole 196 (FIG. 7) to actuate the actuator 198 (FIG. 8) to raise the vent plate 106 (FIG. 7) carrying the air filter 112 (FIG. 7) to its closed position (FIG. 1) wherein the vent plate 106 (FIG. 2) is again in contact with the frame 110 (FIG. 2).

The vent plate 106 (FIG. 7) is adjustable between a plurality of positions between the closed state (FIG. 1) and the open state (FIG. 7) as determined by the length of the ropes 174, 176, 178, 180 and the distance between the teeth of the gears of the gear assembly 172 (FIG. 8) while such adjustability therefore is not infinite, it may be said to be continuous between the open and closed positions. (FIG. 1 and FIG. 7). Actuation of the hoist arrangement 170 turns all the pulleys 174, 176, 178, 180, and thus spools or unspools all the ropes 174, 176, 178, 180 simultaneously depending on the actuation direction.

FIG. 11 shows filtered vent system 100 with main frame member 118 (FIG. 7) removed to illustrate another hoist arrangement 246 that may be used instead of hoist arrangement 170 (FIG. 7). Hoist arrangement 246 is the same as hoist arrangement 170 (FIG. 7) except for the differences described here. Actuator 198 actuates gear assembly 248 which is made up a worm gear 250 which transfers the rotational force of the actuator 198 to gear 252. Rotation of gear 252 in a first rotational direction unspools rope 254 from the first central pully 214. Rotation of gear 252 in a second rotational direction spools rope 254 on the first central pulley 214. Thus, unlike hoist arrangement 170 (FIG. 7) only one rope 254 instead of two ropes 174, 176 (FIG. 7) is spooled to the first central pulley 214. Likewise, only one rope 256 is spool on the second central pulley 216 instead of two ropes 178, 180 (FIG. 7).

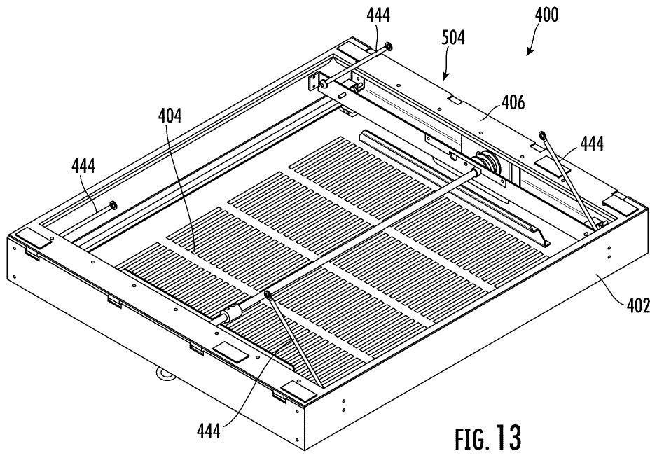

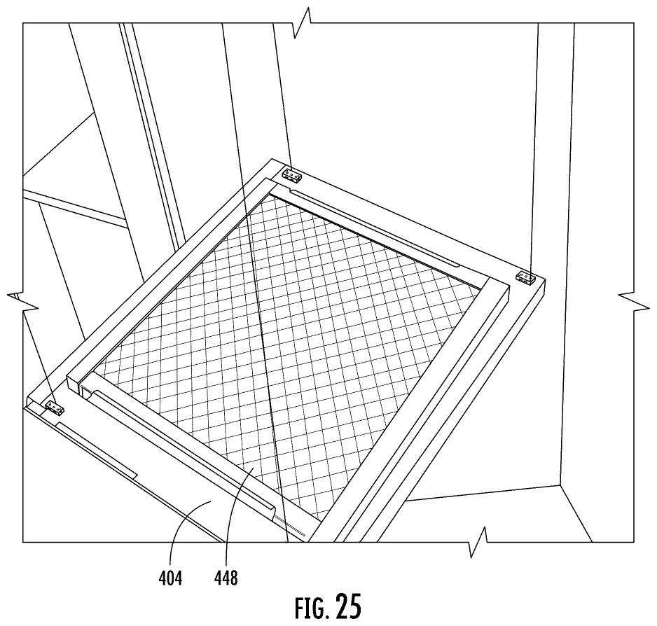

FIG. 13 illustrates another embodiment of a filtered vent system 400 according to the teachings of the instant invention. The filtered vent system 400 is similar to the filter vent system 100 (FIG. 1) except for the differences described herein. The filtered vent system 400 is shown with a vent frame 402 in its closed state and with the air filter 448 (FIG. 25) removed to show the vent plate 404. In the closed state the vent plate 404 is in the vent frame 402 such that the vent plate 404 is surrounded by the vent frame 402.

The vent frame 402 includes a mounting frame 406 on an opposite side of the vent frame 402 from the vent plate 404. The mounting frame 406 differs from the bracket 110 (FIG. 1) because it is a single frame and not a bracket made up of the two separate components of brackets 114, 116 (FIG. 1).

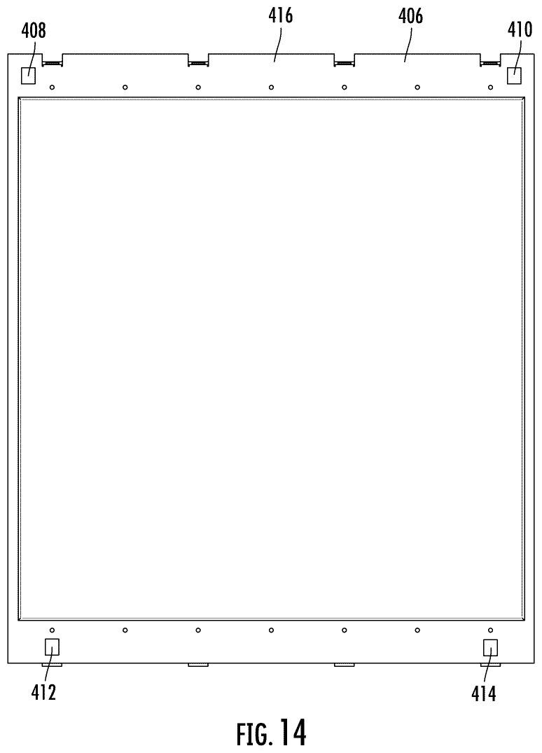

FIG. 14 illustrates the mounting frame 406 with adhesive 408, 410, 412, 414 on a ceiling side 416 of the mounting frame 406. The adhesive may be multiple elements or a single piece, for example double sided tape.

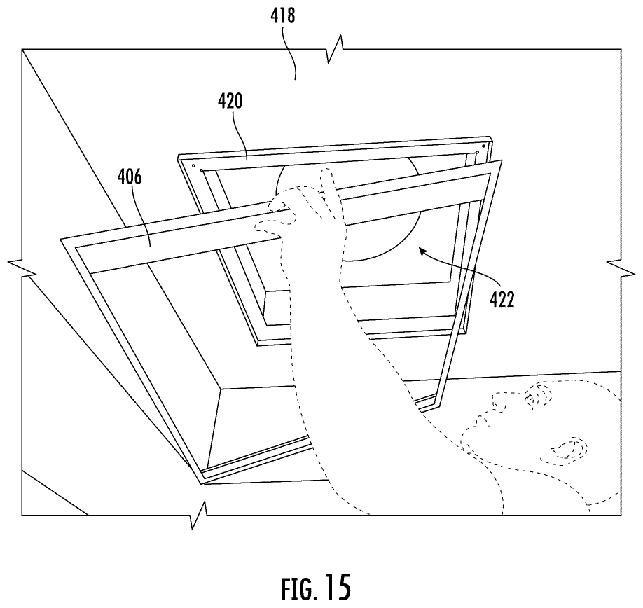

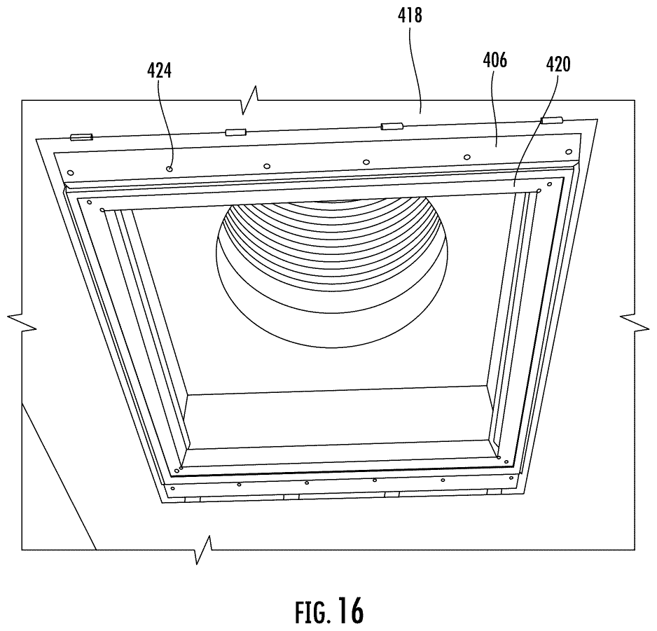

FIG. 15 illustrates the mounting frame 406 just before it is mounted on the ceiling 418 to surround the preexisting vent frame 420 of the return air duct 422. FIG. 16 illustrates the mounting frame 406 aligned around the preexisting vent frame 420 prior to more secure fixation. This is particularly advantageous, particularly as compared to brackets 114, 116 (FIG. 1) because with use of the mounting frame 406, the user then has both hands free to fasten, for example, with screws 424, the mounting frame 406 to the ceiling 418. The mounting frame 406 would not be able to support the weight of the vent frame 402 (FIG. 1) without the screws 424, inserted though the mounting frame 406 to fasten the mounting frame 406 between the ceiling 418 and the heads of the screws 424.

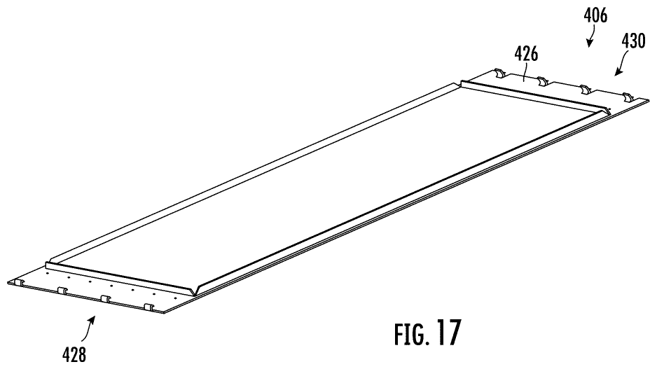

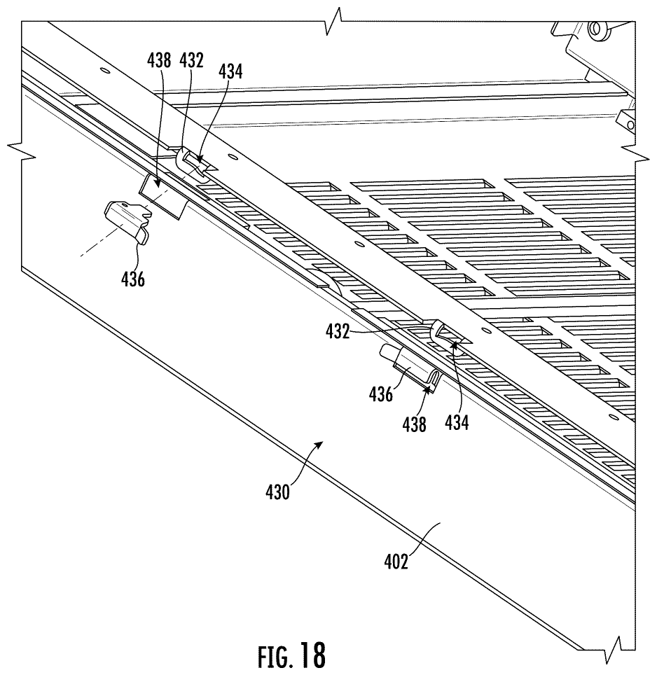

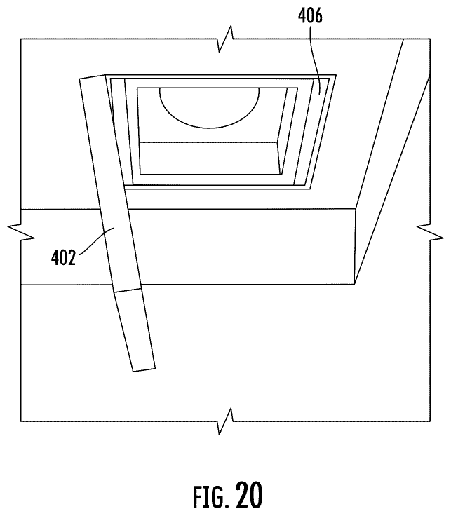

FIG. 17 illustrates a floor facing face 426 of the mounting frame 406. The mounting frame 406 has a hinge side 428 and a latch side 430. The latch side 430 is better seen in FIG. 18 showing a plurality of apertured receiving tabs 432 having through-holes 434 for receiving a plurality of latches 436 (FIG. 18) of the vent frame 402 (FIG. 20). FIG. 18 shows one of the plurality of latches 436 removed from one of the plurality of receiving apertures 438 of the vent frame 402.

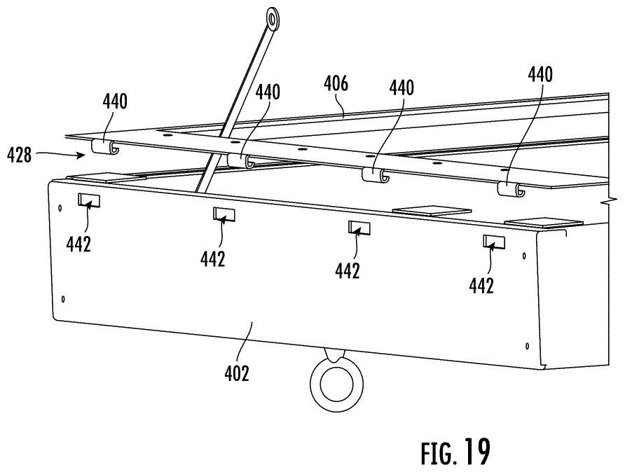

FIG. 19 illustrates a partial view of the hinge side 428 of the vent frame 402. The hinge side 428 includes a plurality of hook members 440 that are received into receiving apertures 440 of the vent frame 402. Because of the hook structure, when the plurality of hook members 440 are received into the receiving apertures 442 a hinged connection is made between the mounting frame 406 and the vent frame 402 as seen in FIG. 20.

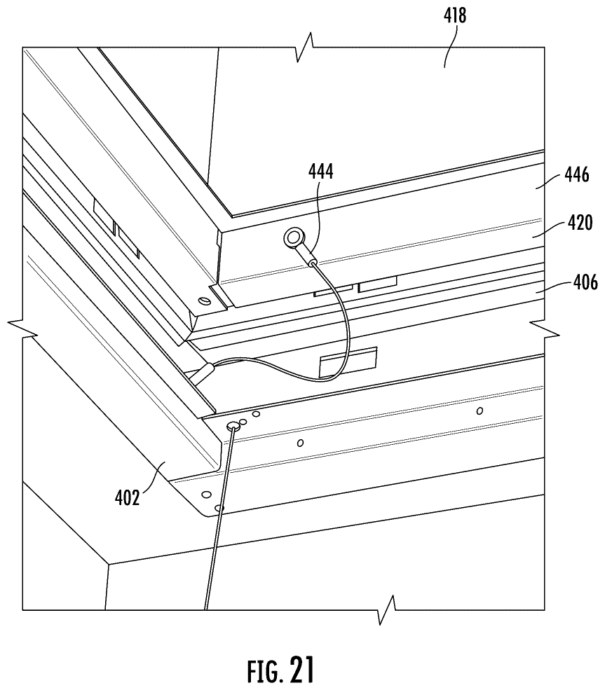

Turning then to FIG. 21, once the hinged connection between the mounting frame 406 and the vent frame 402 has been made, then the installation proceeds by fixing a plurality of safety lanyards 444 (See also FIG. 13) located at corners of the vent frame 402 to studs 446 in the ceiling 418 to which the preexisting vent frame 420 is fixed. The plurality of safety lanyards 444 ensure that even if for some reason the hook members 440 (FIG. 19) or the latches 436 (FIG. 18) were to fail and lose contact with the receiving apertures 438 (FIGS. 18) and 442 (FIG. 19), the safety lanyards 444 would keep the vent frame 402 from falling.

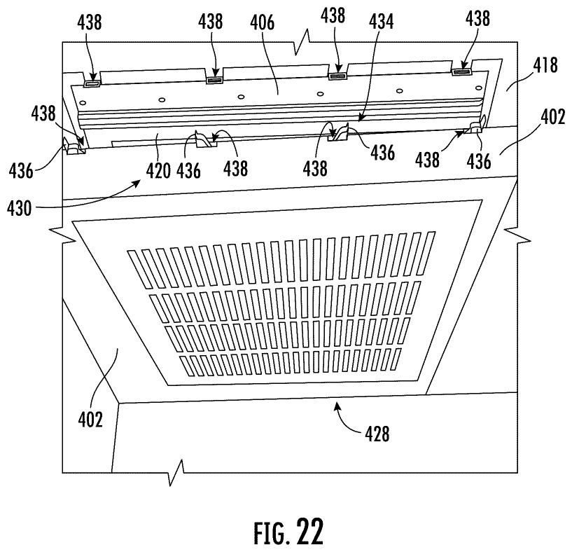

FIG. 22 illustrates the vent frame 402 after it has been rotated about the hinged side 428 to bring latch side 430 and its plurality of latches 436 into contact with the plurality of apertured receiving tabs 432 (FIG. 18) of the mounting frame 406. Each one of the plurality of latches 436 is then rotated to protrude into the receiving apertures 438 of the vent frame 402 and through the plurality of apertured receiving tabs 432 (FIG. 18)

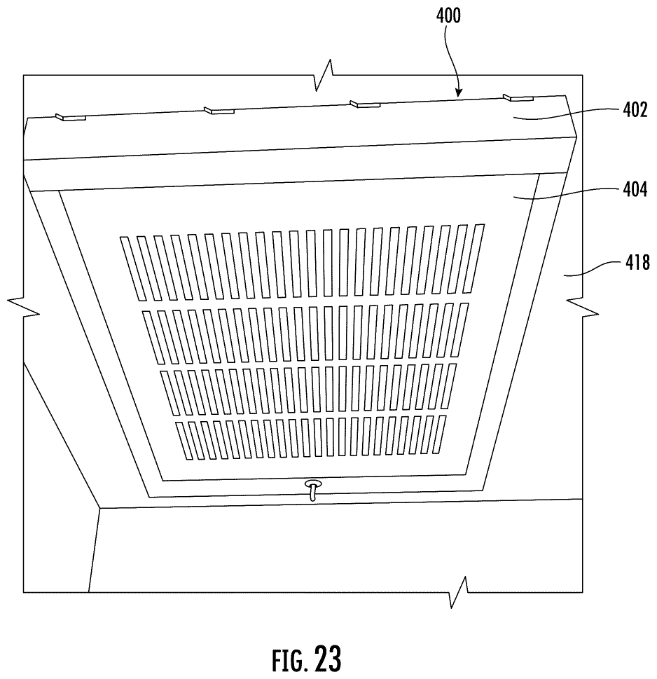

FIG. 23 illustrates the installed filtered vent system 400 on the ceiling 418 with its vent plate 404 in the closed position in the vent frame 402.

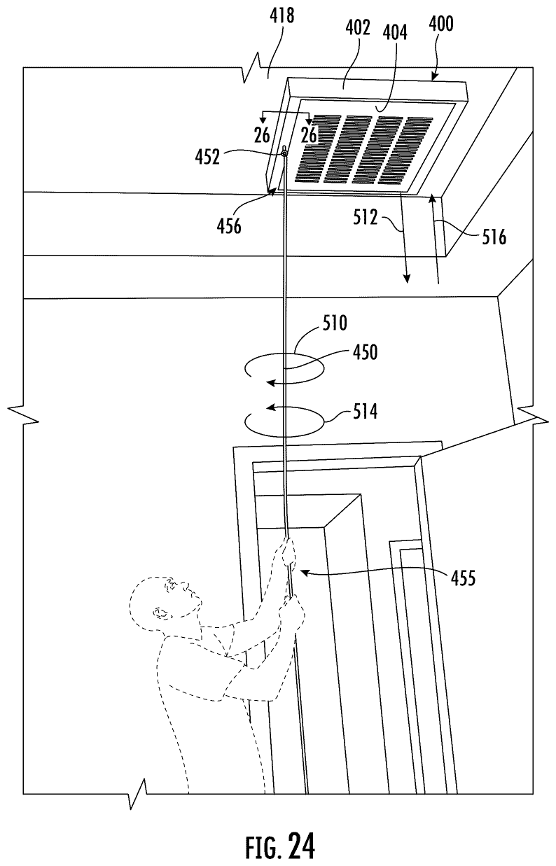

FIG. 24 illustrates the filter vent system 400 installed on the ceiling 418. When necessary and or as scheduled, the filter 448 (FIG. 25) is replaced with a new filter. To change out the filter 448 (FIG. 25), a crank pole 450 is used to actuate an actuator 452 of the filter vent system 400. Thus, rather than having to carry a ladder, place it into position, and then climb the ladder one can merely stand on the floor and use the crank pole 450 reach the filter vent system 400.

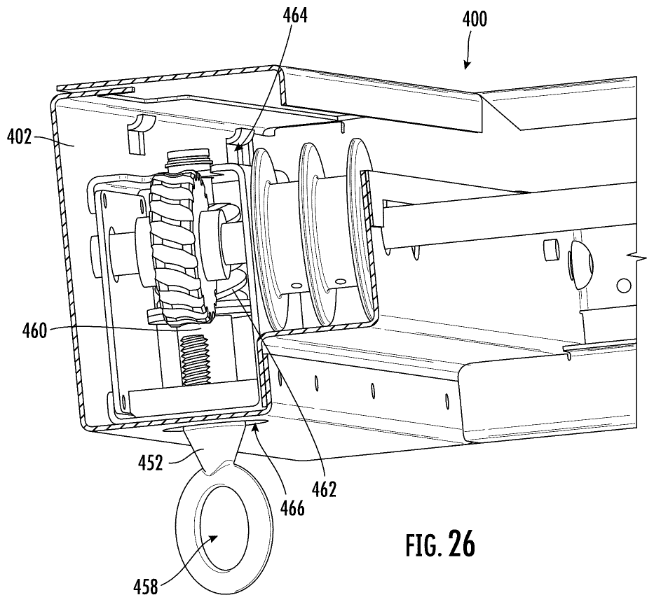

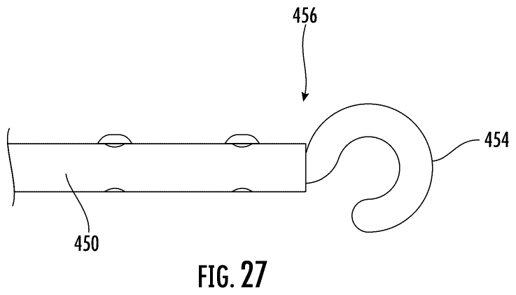

Turning then to FIG. 26, the illustrated cross section is taken about the vent frame 402 of FIG. 24 better illustrates the actuator 452. The actuator 452 has at one end a ring or other geometry, for example, the geometry may be of three or more sides, as in a triangle or parallelogram provided that a hook 454 (FIG. 27) on a second end 456 (FIG. 27) of the crank pole 450 (FIG. 27) can be inserted into the aperture 458 provided by the actuator 452. Therefore, the actuator 452 need not have a completely closed ring, as it could have an end that does not completely close the ring, but rather is a substantially closed ring. By “substantially” in this instance it is meant within five degrees of being completely closed. The actuator 452 at the opposite end of the ring has a threaded end received into a shaft 460 of a worm gear 462 of the hoist arrangement 464 of the filtered vent system 400.

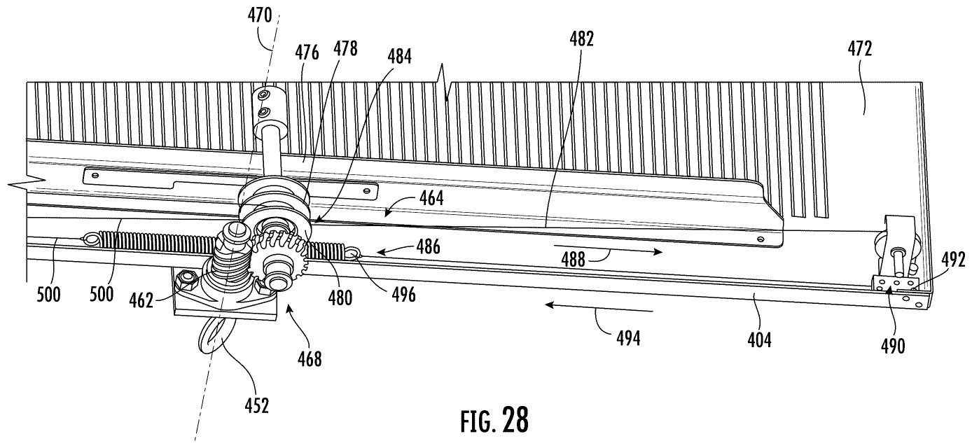

Turning to FIG. 28, the actuator 452 extends through an aperture 466 (FIG. 26) of the vent frame 402 (FIG. 26) to actuate the gear assembly 468 of the hoist arrangement 464. The gear assembly 468 is mounted to the vent frame 402 (FIG. 26) to move the vent plate 404. A longitudinal axis 470 of the worm gear 462 extends in directions generally perpendicularly to a face 472 of the vent plate 404. By “generally” in this instance it is meant within 5 degrees of perpendicular. Surprisingly, it has been found that the worm gear 462 orientation results in more reliability and stability and alignment in the gear assembly 468 relative to the embodiments previously discussed in supporting the weight of the vent plate 404 as it moves from its closed position (FIG. 13) to its open position (FIG. 28).

The hoist arrangement 464 includes a drive pulley 476 having a first spool 478 and a second spool 480. A first rope 482 has first end 484 coiled about the first spool 478. A second end 486 of the first rope 482 is extended in a first direction 488 to extend around a first corner pulley 490. The second end 486 then passes through apertures 490 of a tension block 492 to extend in a second direction 494 opposite the first direction 488 to fasten to an end 496 of an unbiased tensioning spring 498 seated on the vent frame 402. Thus, the hoist arrangement 464 is mounted to the vent frame 402 and connected to the vent plate 402 with the first rope 482.

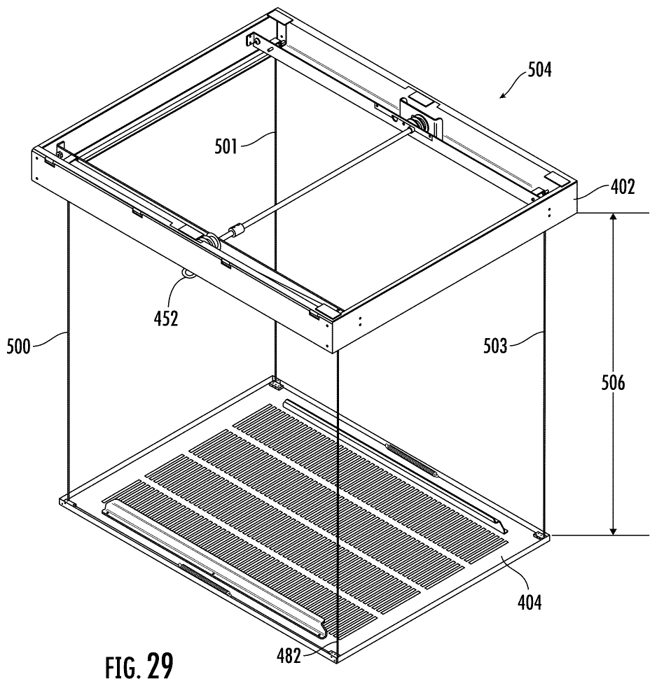

A second rope 500 extends in the second direction 494 and is arranged similar to that which has just been described with respect to the first rope 482. Similarly, this same arrangement is present on the opposite side 504 (FIG. 13) of the vent frame 402 (FIG. 13). The vent plate 404 is connected to the vented frame 402 with the first rope 482 and the second rope 500 (FIG. 29). A third rope 501 (FIG. 29) and a fourth rope 503 (FIG. 29) are similarly arranged on the opposite side 504 of the vent frame 402 connects the vent frame 402 to the vent plate 404. The unbiased tension spring 498 (FIG. 28) cooperates with the apertures 490 (FIG. 28) of the tension block 492 that receive the second end 486 (FIG. 28) of the first rope 482 (FIG. 28) so as to permit sliding of the first rope 482 (FIG. 28) with resistance and provide alignment and to the vent plate 404 as it moves to its open position (FIG. 29).

FIG. 29 illustrates the second state, that is the open state of the vent plate 404 with the filter 448 (FIG. 25) already removed from the vent plate 404 and without the mounting frame 406 (FIG. 13). Thus, in the second state by turning the actuator 452 the vent plate 404 moves from a first state (FIG. 13) where it is located in and substantially surrounded by the vent frame 402 (FIG. 13) to a second state wherein the vent plate 404 is located axially outside the vent frame 402 and spaced apart from the vent frame 402 a distance 506 that is sufficient to permit removal of the air filter 448 (FIG. 25). By “axially outside” it is meant a center of the vent frame 402 has an axis passing therethrough that is perpendicular to the ceiling 418 (FIG. 24) where the vent frame 402 is located on the ceiling 418 (FIG. 24). In the open state, the vent plate 404 is locate gravitationally below the vent frame 402 and therefore the vent plate is 404 is not surrounded by the vent frame 402 or in the vent frame 402.

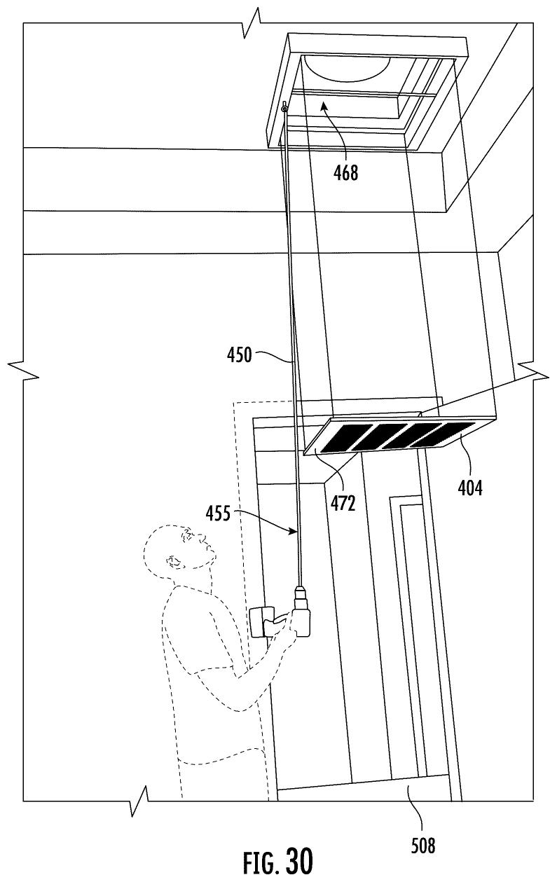

The distance 506 permits the vent plate 404 to be about chest height to the person changing out the filter 448. Therefore, for example, where there is an eight foot high ceiling (approximately 2.4 meters) 418 (FIG. 23), the distance 506 may be greater than 0.5 meters and in a more preferred embodiment 1.5 meters. Where the ceiling height is greater or lesser than 8 feet, then the length of the ropes 482, 500 can be shortened or lengthened as desired to achieve the distance 506 that is desired. The intention for the configuration of the hoist arrangement 464 (FIG. 28) is for the user to be able to stand on the floor 508 (FIG. 30) without having to use a ladder to change out the filter 448 (FIG. 25).

To actuate the hoist arrangement 464 (FIG. 26) the second end 456 (FIG. 24) of a crank pole 450 (FIG. 24) is inserted into the aperture 458 (FIG. 26) of the ring of the actuator 452 (FIG. 26) of the hoist arrangement 464 (FIG. 26). A first end 455 (FIG. 24) of the crank pole 450 (FIG. 24) is rotated in a first rotational direction 510 (FIG. 24) to rotate the crank pole 450 (FIG. 24) in the first rotational direction 510 (FIG. 24) to actuate by turning in the first rotational direction 510 (FIG. 24) the actuator 452 (FIG. 24) of the hoist arrangement 464 (FIG. 26) to move the vent plate 404 (FIG. 24) in a first linear direction 512 (FIG. 24) from the first state (FIG. 13) to the second state (FIGS. 29 and 30).

The open second state can be any distance 506 (FIG. 29) that permits removal of the filter 448 (FIG. 25). Rotating the second end 456 (FIG. 24) of the crank pole 450 (FIG. 24) in a second rotational direction 514 (FIG. 24), opposite the first rotational direction 510 (FIG. 24), rotates the crank pole 450 (FIG. 24) in the second rotational direction 514 (FIG. 24) to actuate by turning in the second rotational direction 514 (FIG. 24) the actuator 452 (FIG. 24) of the hoist arrangement 464 (FIG. 26) to move the vent plate 404 (FIG. 24) in a second linear direction 516 (FIG. 24) opposite the first linear direction 512 (FIG. 24) from the second state (FIGS. 29 and 30) to the first state (FIG. 13).

FIG. 30 illustrates the crank pole 450 can be turned by use of an electric hand drill attached to the first end 455 of the crank pole 450 instead of manually turning the crank pole 450 as seen in FIG. 24.

As seen in FIG. 30 the hoist arrangement 468, moves the vent plate 404 such that the face 472 of the vent plate 404 remains substantially parallel to ground 508 as it moves.

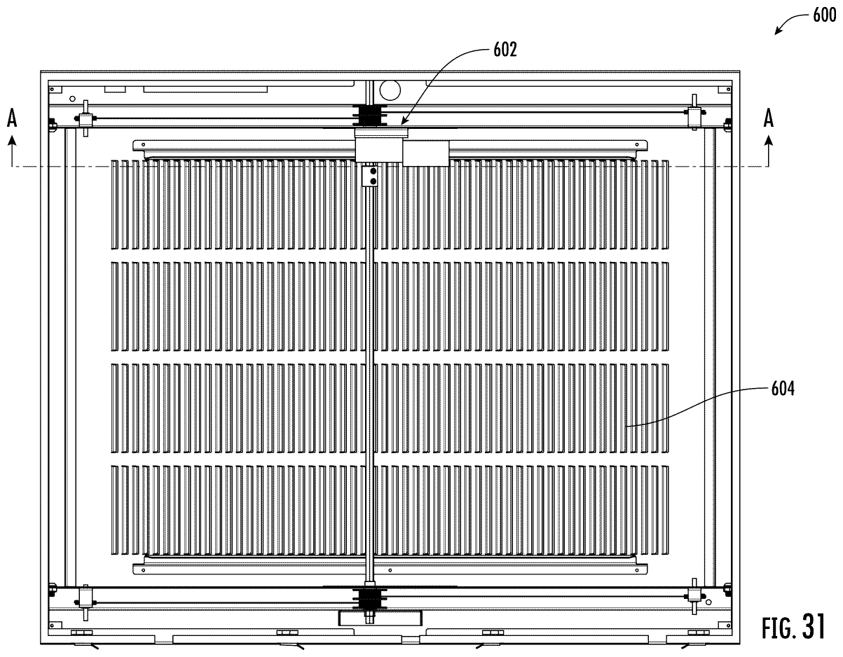

Turning now to FIG. 31, a filter vent system 600 that is electrified is illustrated. The filtered vent system 600 that is electrified is the same as the filter vent system 400 except for the differences discussed herein.

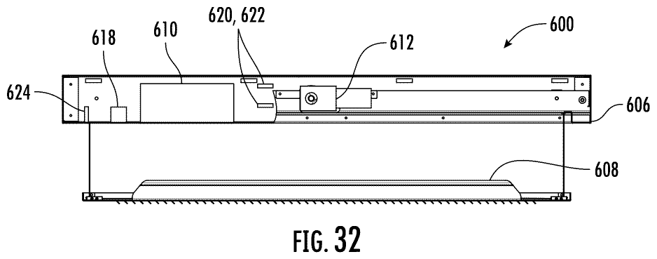

In this embodiment the hoist arrangement 602 is actuable via electrical power to move the vent plate 604 from a first state in contact with the vent frame 606 to a second state free from contact with the vent frame 606 and spaced apart from the vent frame 606 a distance permitting removal of the air filter 608 (FIG. 32).

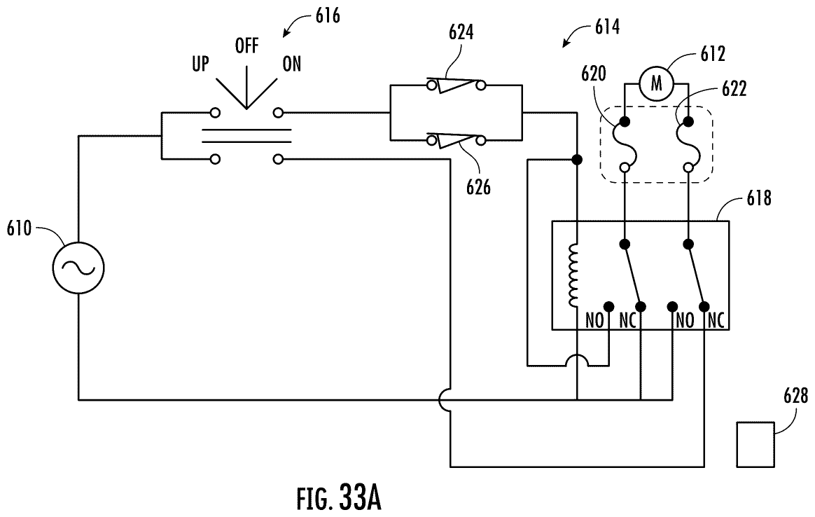

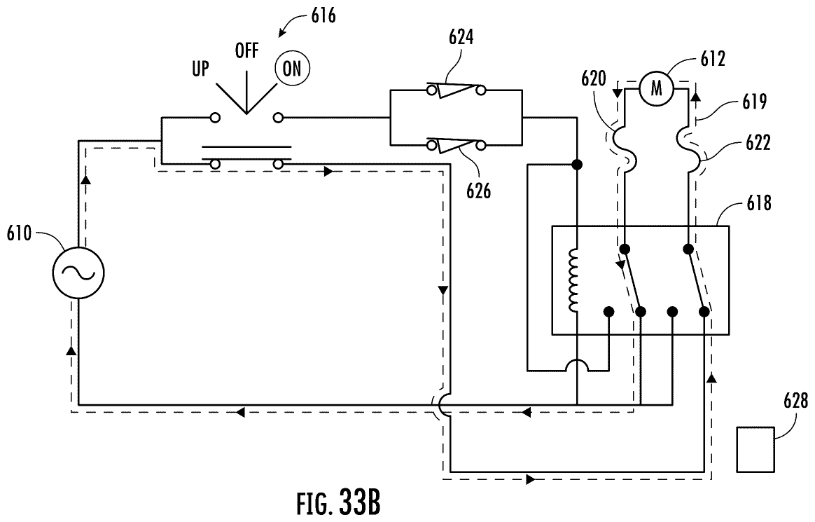

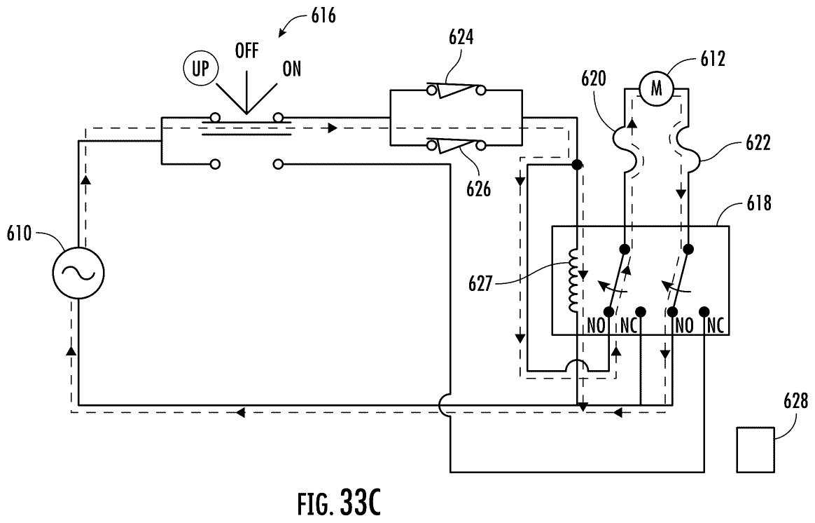

Turning to FIGS. 33A, 33B and 33C, an exemplary embodiment is illustrated. The electrical power may be supplied by utility power as alternating current (AC) to a power supply 610 (FIG. 32) of the hoist arrangement 602 (FIG. 31) configured, as known in the art, for providing direct current (DC) to a motor 612 of the hoist arrangement 602. Alternatively, the electrical power may be supplied by a power supply 610 that is a battery providing direct current (DC) to the motor 612.

The electrical power is supplied to an electrical circuit 614 that include a three-position switch 616 that is typically located on a wall near the filter vent system 600 for ease of access by the user walking on the floor of building.

The three-position switch 616 is designed with a spring that naturally holds it in the “off” position. Moving the three-position switch from the first, “off” position (FIG. 33A), to a its second position (FIG. 33B) and holding it in the second position results in the hoist arrangement 602 (FIG. 32) lowering the vent plate 604 (FIG. 32) to place the filter vent system 600 (FIG. 31) in its second state, that is its open state. Moving the three-position switch 616 to its second position triggers a two-way relay 618, to energize (current flow 619) a first circuit that permits the supply of power from the power supply 610 to the motor 612. The power supplied to the motor 612 is regulated by a pair of inline fuses 620, 622. The pair of in-line fuses 620, 622 are in place to prevent the motor 612 from overloading.

The motor 612 is wired to control the rotational direction necessary for raising and lowering the vent plate 604. The rotational direction may be clockwise in a first rotational direction and counter-clockwise in a second rotational direction opposite the first rotational direction. When the three-position switch 616 is released, because it is biased by a spring, it moves from its second position to its first position. This opens the circuit, stopping the current flow 619 and stops the vent plate 604 from lowering any further.

Wireless communication can be used in the form of a handheld device 628 that transmits a signal to energize the electrical circuit 614 so as to raise or lower the vent plate 604 as desired by the user.

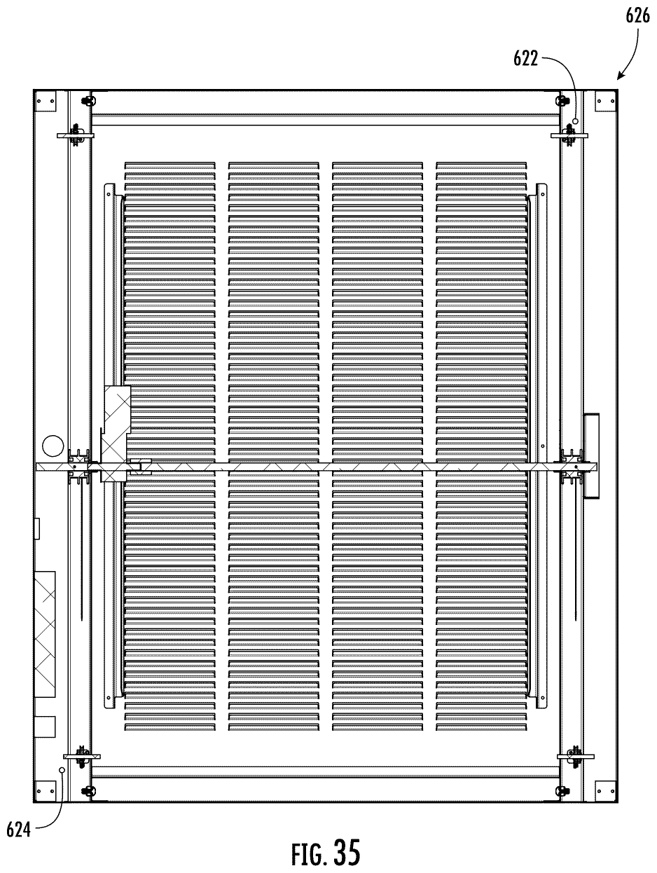

Moving the three-position switch to a third position (FIG. 32C) results in current flow through the pair of limit switches 622, 624 (see also the cross section of FIG. 35) and wired in parallel. Therefore, when the vent plate 504 reaches its closed position abutting the vent frame 606, the pair of limit switches 622, 624 are engaged and the circuit opens to stop the current flow and stop the motor 612. Because the limit switches 622, 624 are wired in parallel, both must be depressed for the motor 612 to stop. This feature aids in ensuring that the vent plate 504 returns in a level state relative to the floor.

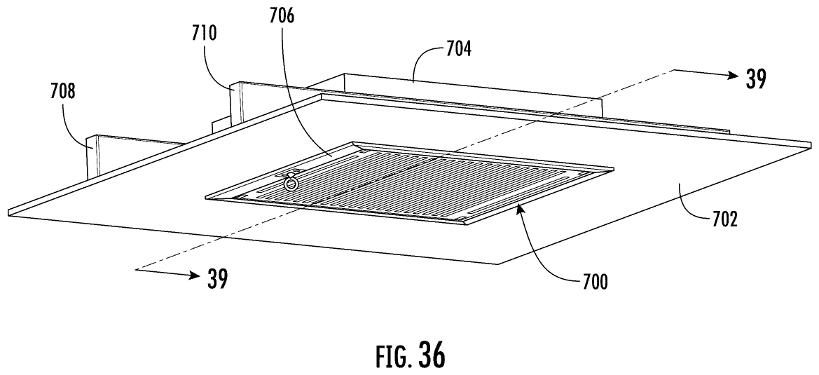

FIG. 36 represents yet another embodiment of a filter vent system 700 according to the teachings of the instant invention. The filter vent system 700 can be structured and operable as previously described with respect to filter vent system 100 (FIG. 1), filter vent system 400 (FIG. 13), and filter vent system 600 (FIG. 31) except for the differences described herein.

Filter vent system 700 mounts flush with the ceiling 702 and in fluid connection with the return air duct 704 located in the ceiling 702. Accordingly, filter vent system 700 is intended to completely replace a prior vent system in the ceiling 702, or alternatively, can be used in new construction as an initially installed filter vent system 700 for the return air duct 704 in the ceiling 702.

In order to facilitate a flush mounting with the ceiling 702, a vent frame 706 is provided that mounts directly to the existing ceiling rafters 708, 710 which are typically spaced at least 12 inches apart but can be spaced at any desired interval, typically up to 24 inches as readily understood in the art. Accordingly, the vent frame 706 is manufactured to the necessary dimensions to accommodate the desired mounting between the rafters 708, 710.

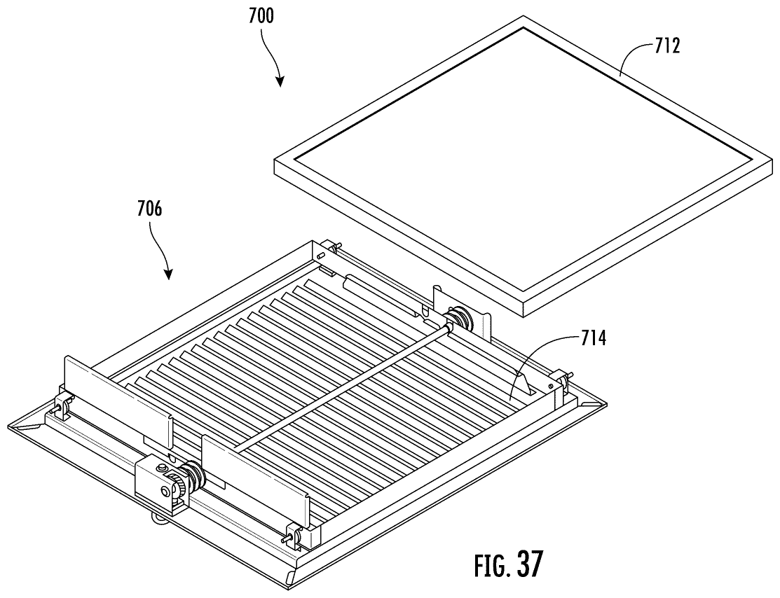

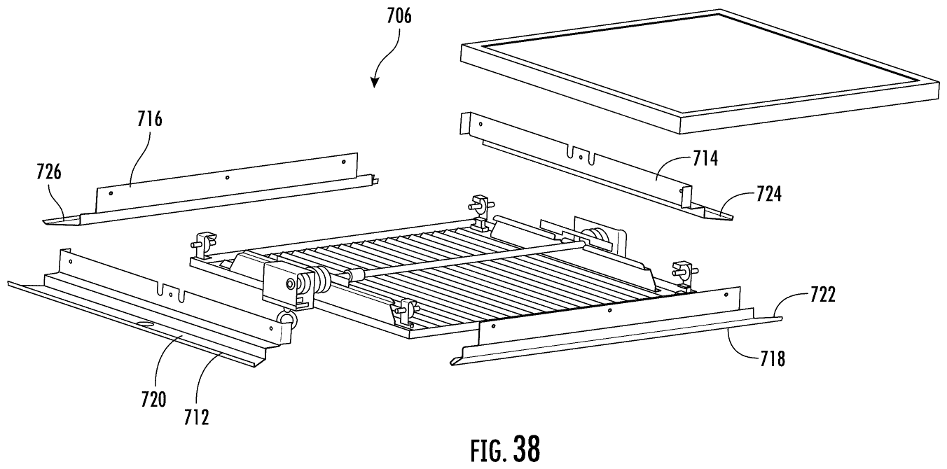

Turning then to FIG. 37, the filter vent system 700 is illustrated with the filter 712 removed from the vent plate 714 to better illustrate the vent frame 706. FIG. 38 illustrates a partial assembly view of the vent frame 706. The vent frame 706 includes a front frame member 712 and back frame member 714 spaced apart in parallel relation such that when the vent frame 706 is mounted in the ceiling 702 (FIG. 36), the front frame member 712 and the back frame member 714 extend transversely between the ceiling rafters 708, 710 (FIG. 36).

The vent frame 706 includes a first side member 716 and second side member 718 spaced apart in parallel relation. The first side member 716 and the second side member 718 each extend between the first frame member 712 and the back frame member 714. The front frame member 712, back frame member 714, first side member 716, and second side member 718 may be joined at their ends via weldment, fasteners, tab and grooves as readily understood in the art. When the vent frame 706 is mounted to the ceiling 702 (FIG. 36), the first side member 716 and the second side member 718 extend parallel to the ceiling rafters 708, 710 (FIG. 36) that are adjacent ceiling rafters, and can be removably fixed thereto by fasteners, for example screws or nails as readily understood in the art. Thus, the fixation is to surfaces of the ceiling rafters 708, 710 that face one another.

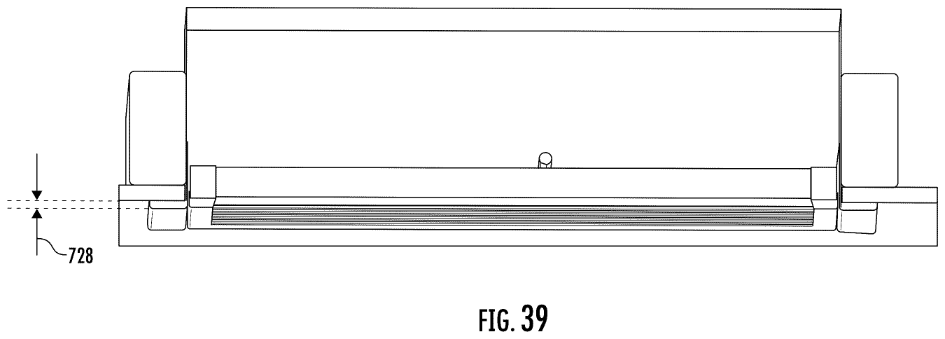

Each one of the front frame member 706, back frame member 708, first side member 710, and second side member 712 have a stepped profile such that a bottom step member 720, 722, 724, 726 provides a surface that abuts the ceiling 702 (FIG. 36) when the vent frame 706 is mounted to the ceiling 702. Accordingly, at this point in the disclosure, it should be apparent to those in the art that by “flush mount” it is meant that a substantial portion of the filter assembly 700 is mounted in the ceiling 702 (FIG. 36) while only the thickness 728 (FIG. 39) of the bottom step member 720, 722, 724, 726 extends from the outermost surface of the ceiling 702 (FIG. 36). FIG. 39 shows a cross section of the filter vent system 700 taken at line 39-39 of FIG. 36 to assist in illustrating the flush mounting to the ceiling 702 and the thickness 728. The thickness 728 in an embodiment may be less than ½ inch (12.7 millimeters) or in a preferred embodiment less than ¼ inch (6.4 millimeters)

Actuation of the filter vent system 700 to move the vent plate 706 from a closed position (See for example FIG. 23 and FIG. 36) to open position (as in FIG. 25) in order to change the filter 712 therein may be either by mechanical actuation, as described in the previous embodiments of filter vent systems 100 (FIG. 1) and 400 (FIG. 13), or electrical as described with the previous embodiment 600 (FIG. 31).

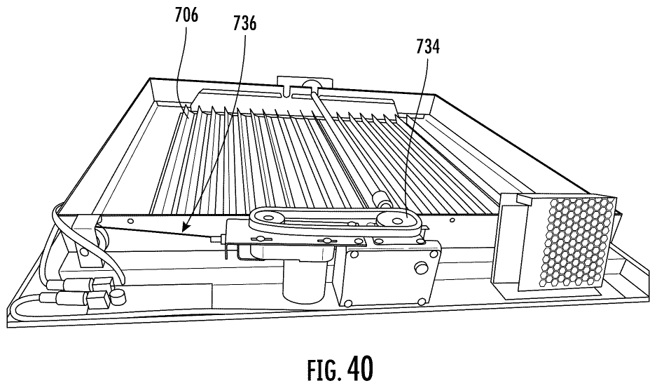

FIG. 40 shows the filter vent system 700 with a motor 730 and controller 732 to effectuate the electrical actuation via electrical energization of the electrical circuit 738 as previously described with respect to the filter vent system 600 (FIG. 31). The electrical power supplied to the motor 730 effectuates the rotation of the gear assembly 734 of the hoist arrangement 736. So too, as with filter vent system 600 (FIG. 31), wireless communication can be used in the form of a handheld device that transmits a signal to energize the electrical circuit 738 and thus the motor 730 so as to raise or lower the vent plate 706 as desired by the user.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filtered vent system for a return air duct in a ceiling, the filtered vent system comprising:
a bracket configured to mount to the ceiling;
a vent frame configured to be mounted the bracket to fix the vent frame to the ceiling;
a vent plate carrying an air filter;
a hoist arrangement mounted to the vent frame and connected to the vent plate;
wherein the hoist arrangement is actuable via electrical power to move the vent plate from a first state in contact with the vent frame to a second state free from contact with the vent frame and spaced apart from the vent frame a distance permitting removal of the air filter.

2. The filtered vent system of claim 1, where the electrical power is provided by utility power or by a battery.

3. The filtered vent system of claim 1, wherein the electrical power is supplied to an electrical circuit comprising:
a three-position switch;
a power supply;
a two-way relay;
a motor;
a pair of inline fuses;
a pair of limit switches.

4. The filtered vent system of claim 3, wherein the three position switch includes a spring that biases the switch in a first position that is an off position wherein no electrical power is supplied to the motor.

5. The filtered vent system of claim 4, wherein the three position switch has a second position that triggers the two way relay to allow electrical current of the electric power to flow to the motor to turn the motor in a first rotational direction and move the vent plate from the first state to the second state.

6. The filtered vent system of claim 5, wherein the three position switch has a third position that triggers the two way relay to allow the electrical current to flow to the motor to turn the motor in a second rotational direction, opposite the first rotational direction, to move the vent plate from the second state to the first state.

7. The filtered vent system of claim 6, wherein the pair of limit switches are configured to stop the motor when the vent plate moves from the second state to the first state.

8. The filtered vent system of claim 7, wherein the pair of limit switches are located at opposite diagonal corners of the vent frame and are wired in parallel, the pair of limit switches activated when the vent plate reaches the second state, wherein to maintain the vent tray in a level position, both limit switches of the pair of limit switches must be activated to stop the motor and keep the vent plate in the second state.

9. The filtered vent system of claim 3, wherein the pair of inline fuses prevent the motor from overheating.

10. The filtered vent system of claim 1, wherein the hoist assembly comprises:
an axel rotatably mounted on the vent frame, a first end of the axel located on a first side of the vent frame and a second end of the axel located on a second side of the vent frame opposite the first side;
a gear and a first central pulley mounted at the first end of the axel and a second central pully mounted at the second end of the axel;
a motor configured to rotationally turn the gear, the axel, the first central pulley and the second central pulley; and
wherein the motor is located on the vent frame.

11. The filtered vent system of claim 10, wherein the hoist arrangement further comprises a power supply, the power supply supplying the electrical power to the motor.

12. The filtered vent system of claim 10, the hoist arrangement further comprising a first set of pulleys mounted to the frame and connected to the first central pulley and a second set of pulleys mounted to the frame and connected to the second central pulley; wherein the first central pulley, the second central pulley, the first set of pulleys and the second set of pulleys are rotatable in a first rotational direction and a second rotational direction opposite the first rotational direction.

13. The filtered vent system of claim 12, wherein a first portion of ropes connect the first set of pulleys to the first central pulley and to the vent plate and a second portion of ropes connect the second set of pulleys to the second central pulley and to the vent plate; wherein the first portion of ropes and the second portion of ropes are in an unbiased state in the first state of the vent plate and in the second state of vent plate and in any position between the first state of the vent plate and the second state of the vent plate.

14. The filtered vent system of claim 12, wherein the first set of pulleys are connected to the second set of pulleys by a first axel at a first end of the frame and by a second axel at a second end of the frame and wherein the axel is located between the first axel and the second axel.

15. The filtered vent system of claim 13, wherein rotation of the motor in either the first rotational direction or the second rotational direction simultaneously rotates the first central pulley and the first set of pulleys and the second central pulley and the second set of pulleys to either unwind or wind the first portion of ropes and the second portion of ropes about the first central pulley and the second central pulley so as to move the vent plate either from the first position to the second position or from the second position to the first position.

16. A filtered vent system for a return air duct in a ceiling, the filtered vent system comprising:
a vent frame configured to be mounted to the ceiling;
a vent plate carrying an air filter;
a hoist arrangement mounted to the vent frame and connected to the vent plate;
wherein the hoist arrangement is actuable to move the vent plate from a first state in contact with the vent frame to a second state free from contact with the vent frame and spaced apart from the vent frame a distance permitting removal of the air filter.

17. The filter vent system of claim 16, wherein the vent frame defines an aperture configured to receive an actuator therethrough to actuate the hoist arrangement to move the vent plate from the first state in contact with the vent frame to the second state free from contact with the vent frame.

18. The filter vent system of claim 16, wherein the vent frame is configured to extend less than 12.7 millimeters away from the ceiling when mounted thereto.

19. The filter vent system of claim 16, wherein the vent frame is configured to extend less than 6.4 millimeters away from the ceiling when mounted thereto.

20. The filter vent system of claim 16, wherein the wherein the hoist arrangement is actuable via electrical power to move the vent plate.

21. The filter vent system of claim 20, wherein the vent frame comprises:
a front frame member;
a back frame member spaced apart from the front member and in parallel relation to the front member;
a first side member;
a second side member spaced apart from the first side member an in parallel relation to the second side member,
wherein the first side member and the second side member each extend between the first frame member and the back frame member.

22. The filter vent system of claim 21, wherein the hoist assembly comprises:
an axel rotatably mounted on the vent frame, a first end of the axel located on either the front side member of the vent frame or the back side member of the vent frame and a second end of the axel opposite the first end of the axel located on either the front side member of the vent frame or the back side member of the vent frame;
a gear and a first central pulley, the gear mounted on either the front side member or the back side member and a second central pully mounted at the second end of the axel;
a motor mounted on either the front side member or the back side member, the motor configured to rotationally turn the gear, the axel, the first central pulley and the second central pulley.

23. The filtered vent system of claim 20, wherein the electrical power is supplied to an electrical circuit comprising:
a three-position switch;
a power supply;
a two-way relay;
the motor;
a pair of inline fuses;
a pair of limit switches.

24. The filtered vent system of claim 23, wherein the three position switch includes a spring that biases the switch in a first position that is an off position wherein no electrical power is supplied to the motor.

25. The filtered vent system of claim 24, wherein the three position switch has a second position that triggers the two way relay to allow electrical current of the electric power to flow to the motor to turn the motor in a first rotational direction and move the vent plate from the first state to the second state.

26. The filtered vent system of claim 25, wherein the three position switch has a third position that triggers the two way relay to allow the electrical current to flow to the motor to turn the motor in a second rotational direction, opposite the first rotational direction, to move the vent plate from the second state to the first state.

27. The filtered vent system of claim 26, wherein the pair of limit switches are configured to stop the motor when the vent plate moves from the second state to the first state.

28. The filtered vent system of claim 22, wherein the motor is located on either the front frame member or the back frame member.

29. The filter vent system of claim 28 configured to mount to the ceiling by fixing the first side member or the second side member to adjacent rafters such that the motor is located between the adjacent rafters.

30. The filter vent system of claim 23, wherein a handheld device transmits a signal to energize the electrical circuit to energize the motor so as to raise or lower the vent plate as desired by the user.
